(19) United States
(12) Patent Application Publication
(10) Pub. No.: US 2024/0185199 A1
(43) Pub. Date: Jun. 6, 2024

(54) PAYMENT REMITTANCE SUPPORT SYSTEM, INFORMATION PROCESSING APPARATUS, PAYMENT REMITTANCE SUPPORT METHOD, AND STORAGE MEDIUM

(71) Applicants: LOGISTEED, LTD., Tokyo (JP); Uhuru Corporation, Tokyo (JP)

(72) Inventors: Takashi WATANABE, Tokyo (JP); Noriyuki NEMOTO, Tokyo (JP); Masahito TANIGUCHI, Tokyo (JP); Motoyuki SAKODA, Tokyo (JP)

(21) Appl. No.: 17/905,773

(22) PCT Filed: Mar. 12, 2020
(86) PCT No.: PCT/JP2020/010812

§ 371 Date: Sep. 7, 2022

(51) Int. Cl. G06Q 20/14; G06Q 30/0601

(52) U.S. Cl. CPC G06Q 20/14; G06Q 30/0635

(57) ABSTRACT

A payment remittance support system according to one aspect includes an order placement terminal configured to provide contract information indicating a payment for and contents of a job for which an order is placed; an order reception terminal configured to provide completion information, which indicates completion of the job for which the order was accepted, such that the completion information is linked to the contract information; and a remittance unit configured to cause remittance processing for the payment indicated in the contract information linked to the completion information to be executed.

### TECHNICAL FIELD

The present disclosure relates to payment remittance support systems, information processing apparatuses, payment remittance support methods, and programs.

### BACKGROUND ART

Techniques for job management are gaining attention. Patent Document 1 cited below proposes a technique for creating a program composed of a construction work request information disclosure system, a subcontractor availability displaying system, an order placement/order reception system, a material procurement system, a material delivery system, a job management system, a job completion confirmation verification system, a billing system, and a payment confirmation system; and managing jobs in accordance with the systems by allowing the personal computer of a management company, the respective personal computers of cooperating companies, and the respective mobile terminals of workers to operate, view, and write in the program.

### RELATED-ART DOCUMENTS

### Patent Documents

Patent Document 1: Japanese Patent Laid-Open No. 2010-267219

### SUMMARY OF INVENTION

### Technical Problem

However, a technique for improving convenience and immediacy in order placement and order reception of jobs is further desired. For example, in a case where a payment is to be remitted after the completion of all of jobs in work that includes a plurality of jobs and the jobs overall are spread over a long period, an order receiving entity may have difficulty allocating money to expenses for the jobs since the payment will not be remitted at the stage when only some of the jobs have been completed. Furthermore, for example, in a case where a plurality of jobs are to be executed by dividing the jobs among a plurality of entities, the processing for remitting respective payments to the entities can be complicated.

### Solution to Problem

According to the first aspect of the present disclosure, there is provided a payment remittance support system including: an order placement terminal configured to provide contract information indicating a payment for and contents of a job for which an order is placed; an order reception terminal configured to provide completion information, which indicates completion of the job for which the order was accepted, such that the completion information is linked to the contract information; and a remittance unit configured to cause remittance processing for the payment indicated in the contract information linked to the completion information to be executed.

According to the second aspect of the present disclosure, there is provided an information processing apparatus including: an acquisition unit configured to acquire contract information indicating a payment for and contents of a job for which an order is placed; and an information processing unit configured to analyze a relationship between the contract information and information linked to the contract information.

According to the third aspect of the disclosure, there is provided a payment remittance support method including: a step of providing, by an order placement terminal, contract information indicating a payment for and contents of a job for which an order is placed; a step of providing, by an order reception terminal, completion information, which indicates completion of the job for which the order was accepted, such that the completion information is linked to the contract information; and a step of causing remittance processing for the payment indicated in the contract information linked to the completion information to be executed.

According to the fourth aspect of the disclosure, there is provided a program for causing a computer to execute remittance processing for a payment based on contract information, which indicates the payment for and contents of a job for which an order is placed, and completion information, which is linked to the contract information and is information indicating completion of the job for which the order was accepted.

### Advantageous Effects of Invention

According to the present disclosure, for example, the convenience and the immediacy in remitting payment for a job can be improved.

### BRIEF DESCRIPTION OF DRAWINGS

FIG. 1 is a view illustrating a payment remittance support system according to an embodiment;

FIG. 2 is a block diagram illustrating an example of the hardware configuration of a terminal according to the embodiment;

FIG. 3 is a block diagram illustrating the functional configuration of the payment remittance support system according to the embodiment;

FIG. 4 is a sequence diagram illustrating processing by the payment remittance support system according to the embodiment;

FIG. 5 is a table indicating an example of information stored in a distributed ledger according to the embodiment;

FIG. 6 is a view illustrating an example of an image displayed in an order reception terminal according to the embodiment;

FIG. 7 is a view illustrating an example of another image displayed in the order reception terminal according to the embodiment;

FIG. 8 is a sequence diagram illustrating processing by a payment remittance support system according to an embodiment;

FIG. 9 is a sequence diagram illustrating processing by a payment remittance support system according to an embodiment;

FIG. 10 is a sequence diagram illustrating processing by a payment remittance support system according to an embodiment;

FIG. 11 is a table indicating an example of various types of information according to the embodiment;

FIG. 12 is a view indicating various types of information related to a modification;

FIG. 13 is a sequence diagram illustrating processing according to a payment remittance support system according to an embodiment;

FIG. 14 is a table indicating an example of various types of information according to the embodiment; and

FIG. 15 is a block diagram illustrating a payment remittance support system according to an embodiment.

### DESCRIPTION OF EMBODIMENTS

Embodiments will be described hereinafter with reference to the accompanying drawings. It is assumed that the description of the present specification is in compliance with the laws of the country or region in which the techniques according to the present invention are to be implemented.

### First Embodiment

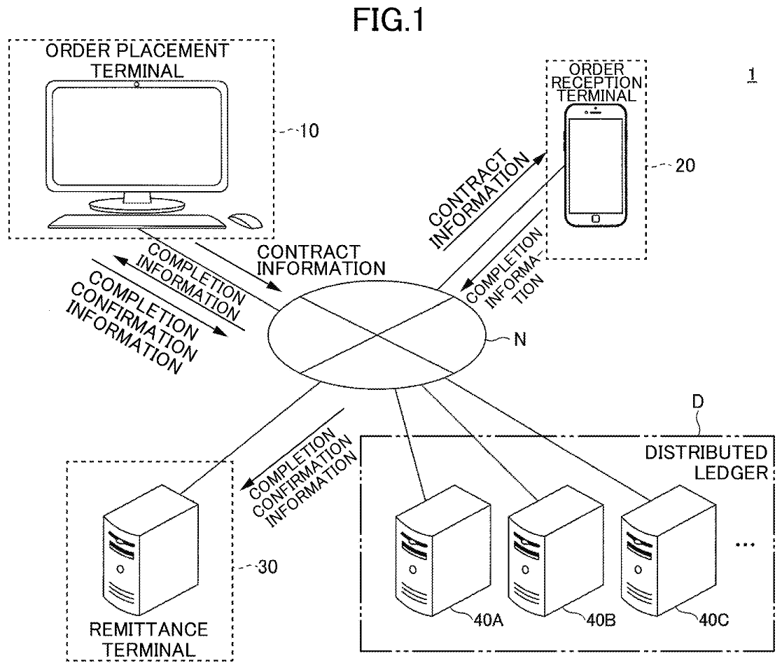

FIG. 1 is a view illustrating a payment remittance support system according to an embodiment. In FIG. 1, a payment remittance support system 1 includes an order placement terminal 10, an order reception terminal 20, a remittance terminal 30, and a distributed ledger D. The order placement terminal 10 is a terminal operated by an order placing entity that orders a job. The order reception terminal 20 is a terminal operated by an order receiving entity that accepts the job. A remittance terminal is a terminal operated by a remitting entity that executes the remittance of a payment. The remitting entity may be assumed to be, for example, an employee of a financial institution or an employee who belongs to a department on the side of the order placing entity and is authorized to make the payment based on approval of the completion of the job.

The payment remittance support system 1 operates, for example, as follows. The order placement terminal 10 provides a piece of contract information indicating contents of and a payment for a job to be ordered. For example, the order placement terminal 10 stores the contract information in the distributed ledger D to provide the contract information. The order reception terminal 20 acquires the contract information from the distributed ledger D. The order receiving entity checks the contents of and the payment for job which are indicated in the contract information, and accepts to receive the order for the job.

The order receiving entity completes the job defined in the contract information. The order reception terminal 20 provides completion information, which indicates the completion of the job whose order was accepted, such that the completion information is linked to the contract information. For example, the order reception terminal 20 provides the completion information such that the completion information is linked to the contract information and stored in the distributed ledger D. The order placement terminal 10 acquires the completion information from the distributed ledger D. The completion information includes, for example, information (for example, an image of a job site) indicating the proof of the completion of the job. The order placing entity confirms the completion of the job based on the completion information. The order placement terminal 10 provides completion confirmation information which indicates confirmation of the completion of the job.

The order placement terminal 10 causes the remittance processing for the payment indicated in the contract information linked to the completion information to be executed. For example, when the completion of a job is confirmed based on the completion information, the order placement terminal 10 causes the remittance processing for the payment to be executed. The order placement terminal 10 provides, for example, the completion confirmation information as information to trigger the execution of the remittance processing. Upon receiving the provision of the completion confirmation information, the remittance terminal 30 executes the remittance processing. Since this type of payment remittance support system 1 causes the remittance processing for the payment indicated in the contract information linked to the completion information to be executed, the remittance of the payment is, for example, executed smoothly, thus contributing to an improvement in the convenience and the immediacy of order placement and order reception.

Each unit of the payment remittance support system 1 will be described hereinafter. Reference numerals 40A, 40B, and 40C of FIG. 1 each indicate a terminal that forms a node of the distributed ledger D. In the following description, in cases where the terminals forming the distributed ledger D need not be discriminated, these terminals will be referred to as terminals 40. Note that the number of the order placement terminals 10, the number of order reception terminals 20, the number of remittance terminals 30, and the number of the terminals 40 are not limited to those in FIG. 1 and may be any number.

Each of the order placement terminal 10, the order reception terminal 20, the remittance terminal 30, and the terminals 40 is a terminal for processing information. The terminal includes, for example, a processor for processing information, a storage unit for storing information, and a communication unit which executes communication based on a predetermined communication standard. Such a terminal may be referred to as an information processing apparatus. An information processing apparatus includes, for example, a stationary computer such as a desktop computer, or a portable computer such as a laptop computer, a tablet, or a smartphone.

Each terminal included in the payment remittance support system 1 is communicably coupled to other terminals included in the payment remittance support system 1 via communication lines N. The configuration and the communication standards of the communication lines N are not limited. The communication lines N may be formed by a single communication network or by a combination of two or more communication networks. The communication lines N may include a wired communication network, a wireless communication network, or both the wired communication network and the wireless communication network. For example, the communication lines N may include at least a part of a local area network (LAN), a wide area network (WAN), a metropolitan area network (MAN), an internet line, a mobile communication network, and a mobile phone network.

The order placement terminal 10 is used by, for example, a person responsible for order placement in a company that orders a job. The order placement terminal 10 is provided in, for example, a facility of the company that orders the job. The order reception terminal 20 is used by, for example, a person responsible for order reception in a company that accepts the order for the job. This person responsible for order reception may be a worker who is to perform the job for which an order has been accepted. The functions of the order reception terminal 20 may be divided between a terminal that is provided in a facility of a company which accepted the order to perform the job and a worker's terminal that is communicably coupled to the terminal provided in the facility of the company. The remittance terminal 30 is, for example, a terminal used by person who is responsible for executing the remittance of a payment in a financial institution. The remittance terminal 30 may be, for example, provided in a facility of a financial institution or may be substituted by a terminal with internet access that can be easily accessed from a department to which a person who has an authority to decide the remittance belongs.

The payment remittance support system 1 according to the embodiment uses the distributed ledger D as a database which is to be a destination for storing information. The distributed ledger D may include a blockchain such as Ethereum® or a tangle such as IOTA®. Note that at least one of the order placement terminal 10, the order reception terminal 20, and the remittance terminal 30 may also serve as one of the terminals 40 which form the nodes of the distributed ledger. The payment remittance support system 1 may also not include at least a part of the distributed ledger D. For example, the distributed ledger D may be at least a part of a different system from the payment remittance support system 1, and the payment remittance support system 1 may use the distributed ledger D as a part of such an external system. The payment remittance support system 1 may use, as the destination for storing information, a storage unit that is formed differently from the distributed ledger D. This storage unit may include, for example, a storage placed in a secure environment.

A program for implementing a cryptoasset wallet may be installed in at least one of the terminals included in the payment remittance support system 1. The cryptoasset wallet may be referred to as a virtual currency wallet, a crypto wallet, or a digital wallet. The aforementioned program may cause a computer to execute processing for managing an encryption key (private key), which is used for a digital signature in a transaction through a distributed ledger, and an address (a crypto address, an anonymous address, or a wallet address) of the distributed ledger to which a user's cryptoasset belongs. The crypto address may be generated based on the hash value of the user's public key which is used in the transaction through the distributed ledger. The aforementioned program may cause the computer to execute processing for transferring cryptoassets.

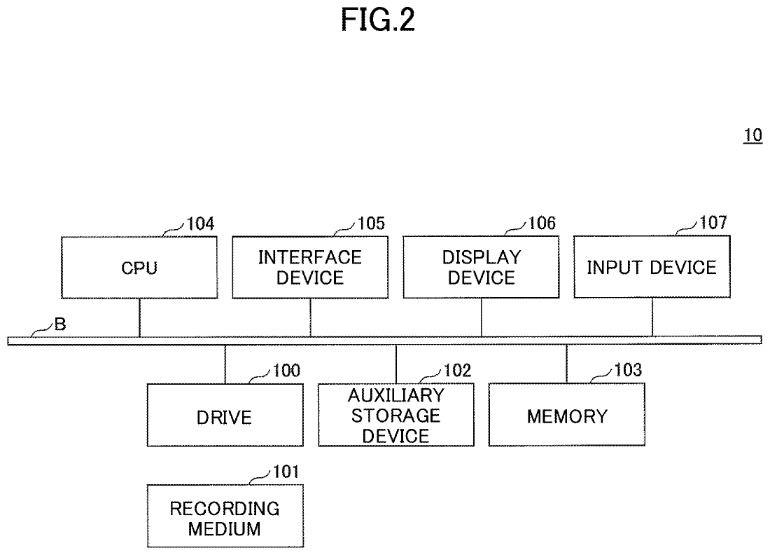

FIG. 2 is a block diagram illustrating an example of the hardware configuration of a terminal according to the embodiment. The hardware configuration of the terminal will be described here based on the example of the order placement terminal 10. The respective hardware configurations of the order reception terminal 20, the remittance terminal 30, and the terminals 40 may be similar to or different from the hardware configuration of the order placement terminal 10 in FIG. 2. The order placement terminal 10 includes a drive 100, an auxiliary storage device 102, a memory 103, a CPU 104, an interface device 105, a display device 106, and an input device 107. These functional units are coupled to each other via a bus B. In the order placement terminal 10, each functional unit is coupled to another functional unit via the bus B.

Programs for implementing processing in the order placement terminal 10 are provided from a storage medium 101. The storage medium 101 includes, for example, a CD-ROM, a DVD disc, or a portable storage medium such as a USB memory. When the storage medium 101 that stores the programs is set on the drive 100, the programs are installed from the storage medium 101 to the auxiliary storage device 102 via the drive 100. The auxiliary storage device 102 holds the stored information even in a state where, for example, the power supply is cut off. The auxiliary storage device 102 includes, for example, a hard disk drive (HDD), a solid state drive (SSD), or a rewritable storage medium such as a flash memory.

The programs to be installed may be provided by a method other than the storage medium 101, and may be provided from, for example, another computer via a network. The auxiliary storage device 102 may store other pieces of information about the programs for causing the terminal to execute processing, and may store, for example, information which is used for processing in the terminal or information which is generated by processing in the terminal. Each of the storage medium 101 and the auxiliary storage device 102 is a computer-readable storage medium.

When an instruction to activate a program is issued, the memory 103 reads a program from the auxiliary storage device 102 and loads the program. The CPU 104 implements, for example, functions related to the order placement terminal 10 in accordance with the program loaded in the memory 103. The interface device 105 is used as an interface for connecting to a network. The display device 106 is a display for displaying a graphical user interface (GUI) or the like of the program. The input device 107 receives, for example, information inputs by being operated by a user. The input device 107 includes, for example, a mouse, a touch pad, or a keyboard. The display device 106 and the input device 107 may be integrated and formed as a touch panel. The terminal according to the embodiment may also include, together with the display device 106 or instead of the display device 106, an output device for outputting information. This output device may output information via, for example, audio. The input device 107 may also accept information input via audio or image.

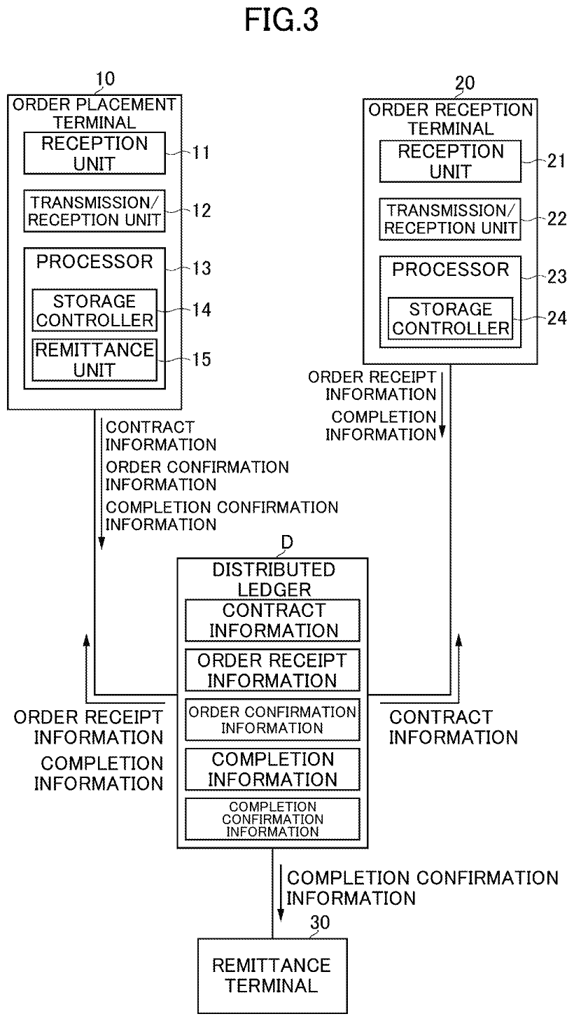

The respective functional configurations of the order placement terminal 10 and the order reception terminal 20 according to the embodiment will be described. FIG. 3 is a block diagram illustrating the functional configuration of the payment remittance support system according to the embodiment.

The order placement terminal 10 includes a reception unit 11, a transmission/reception unit 12, and a processor 13. The reception unit 11 receives various types of information input by the order placing entity. The transmission/reception unit 12 transmits and receives data to and from external devices such as the order reception terminal 20, the remittance terminal 30, and the terminals forming the distributed ledger D. The processor 13 causes each unit of the order placement terminal 10 to execute predetermined processing. The processor 13 is also, for example, a control unit that controls each unit of the order placement terminal 10.

The reception unit 11 receives inputs (to be referred to as an “operation for order placement” as appropriate) of information about a payment for and the contents of a job to be ordered. The processor 13 uses the information received by the reception unit 11 to generate a piece of contract information which indicates the contents of the job to be ordered and the payment for this job. The processor 13 includes a storage controller 14, and the storage controller 14 stores the contract information in a predetermined storage destination. For example, the storage controller 14 controls the transmission/reception unit 12 and causes the transmission/reception unit 12 to transmit the contract information and an instruction to store the contract information. For example, the distributed ledger D receives the contract information and the instruction transmitted from the transmission/reception unit 12, and stores the contract information in accordance with the instruction.

The transmission/reception unit 12 receives a piece of order receipt information. The order receipt information is generated when the order for the job specified in the contract has been accepted. The order receipt information is stored in, for example, the distributed ledger D. The transmission/reception unit 12 receives, for example, the order receipt information from the distributed ledger D. When the transmission/reception unit 12 has received the order receipt information, the reception unit 11 receives an input (to be referred to as an “operation for order confirmation” as appropriate) of information indicating that the order receipt information has been confirmed. When it is determined that the operation for order confirmation has been performed, the processor 13 generates order confirmation information based on the information input to the reception unit 11. The order confirmation information includes, for example, information indicating the order completion or the order confirmation of the job specified in the contract information, information indicating the completion of order reception or the confirmation of the order reception of the job specified in the contract information, or information indicating the establishment or the confirmation of the contract specified in the contract information.

The order placement terminal 10 provides the order confirmation information such that the order confirmation information is linked to the contract information. For example, the contract information includes a piece of identification information (for example, an order ID), and the order confirmation information is linked to the contract information by including the same identification information as the contract information. The order placement terminal 10 (for example, the processor 13) generates the order confirmation information, which is linked to the contract information, by inputting the same identification information as the identification information for the contract information in the order confirmation information. The order placement terminal 10 provides the order confirmation information by storing the order confirmation information in, for example, a predetermined storage destination (for example, the distributed ledger D). For example, the processor 13 controls the transmission/reception unit 12 to cause the transmission/reception unit 12 to execute the transmission of the order confirmation information and an instruction to store the order confirmation information. The distributed ledger D receives, for example, the order confirmation information and the instruction transmitted from the transmission/reception unit 12, and stores the order confirmation information in accordance with the instruction. The distributed ledger D stores the order confirmation information such that the order confirmation information is linked to the corresponding contract information.

The transmission/reception unit 12 receives the completion information. The completion information includes information (to be referred to as “information about proof of job completion” as appropriate) indicating the proof, the evidence, or the basis for the completion of the job specified in the contract information. The completion information is stored in, for example, the distributed ledger D. The transmission/reception unit 12 receives the completion information from, for example, the distributed ledger D. Based on the job completion information provided to the order placement terminal 10, the order placement terminal 10 provides the completion confirmation information such that the completion confirmation information is linked to the contract information. For example, when the transmission/reception unit 12 has received the completion information, the reception unit 11 receives an input (to be referred to as an “operation for order confirmation” as appropriate) of information indicating that the completion information has been confirmed. When it is determined that an operation for completion confirmation has been performed, the processor 13 generates the completion confirmation information which indicates that the completion of the job has been confirmed.

For example, since the contract information includes an order ID, the completion confirmation information can be linked to the contract information by including the same order ID as the order ID of the contract information. The order placement terminal 10 (for example, the processor 13) can input the same order ID as the order ID of the contract information in the completion confirmation information to generate the completion confirmation information which is linked to the contract information. The order placement terminal 10 provides the completion confirmation information by storing, for example, the completion confirmation information in a predetermined storage destination (for example, the distributed ledger D).

The processor 13 includes a remittance unit 15. The remittance unit 15 causes remittance processing for remitting a payment to an order receiving entity based on the contract information to be executed. The remittance unit 15 causes the remittance processing to be executed based on the contract information stored in the distributed ledger D. For example, the remittance unit 15 provides information which is to trigger the execution of the remittance processing, and a terminal which receives this piece of information executes the remittance processing. The aforementioned information which is to be a trigger may be a flag indicating the completion of the job indicated in the contract information, an instruction to execute the remittance processing, or some other piece of information.

The remittance unit 15 provides, as the aforementioned information to be the trigger, the completion confirmation information which indicates that the completion of the job has been confirmed. The remittance unit 15 stores the completion confirmation information in the predetermined storage destination (for example, the distributed ledger D). The remittance unit 15 controls, for example, the transmission/reception unit 12 to cause the transmission/reception unit 12 to execute the transmission of the completion confirmation information and an instruction to store the completion confirmation information. The distributed ledger D receives, for example, the completion confirmation information and the instruction transmitted from the transmission/reception unit 12, and stores the completion confirmation information in accordance with the instruction. The distributed ledger D stores the completion confirmation information such that the completion confirmation information is linked to the contract information.

Note that the order placement terminal 10 may not receive the order receipt information. The order receipt information may also not be generated. The order placement terminal 10 may not transmit the order confirmation information. Each unit of the order placement terminal 10 may be implemented based on the cooperation of one or more programs installed in the order placement terminal 10 and hardware such as the CPU 104 of the order placement terminal 10. The program may cause the computer of the order placement terminal 10 to execute at least some of the above-described processes.

The order reception terminal 20 includes a reception unit 21, a transmission/reception unit 22, and a processor 23. The reception unit 21 receives various types of operations from the order receiving entity. The transmission/reception unit 22 transmits and receives data to and from external devices such as the order placement terminal 10, the remittance terminal 30, and the terminals forming the distributed ledger D. The processor 23 causes each unit of the order reception terminal 20 to execute predetermined processing. The processor 23 is also, for example, a control unit that controls each unit of the order reception terminal 20.

The transmission/reception unit 22 receives at least a part of the contract information provided by the order placement terminal 10. For example, the transmission/reception unit 22 receives the contract information which is stored in the distributed ledger D and is transmitted from the distributed ledger D. When the transmission/reception unit 22 receives the contract information, the reception unit 21 receives an input (to be referred to as an “operation for order reception”) of information indicating that the order has been accepted for at least some of the jobs in the specified in the contract information. The processor 23 uses the information input in the reception unit 21 to generate the order receipt information.

The order receipt information includes, for example, information specifying the job (for example, the order ID) which has been accepted and information (for example, an order receiving entity ID) for specifying the order receiving entity. The order receipt information may include information indicating a payee of the payment. For example, the information indicating the payee of the payment includes information (for example, an account number) specifying the account of the order receiving entity. The account of the order receiving entity may be a savings account in a financial institution or may be another account (for example, a member account). The account of the order receiving entity may be an account of a service provided via the internet.

The order reception terminal 20 provides the order receipt information such that the order receipt information is linked to the contract information. For example, since the contract information includes the order ID, the order receipt information is linked to the contract information by including the same order ID as the order ID of the contract information in the order receipt information. The order reception terminal 20 (for example, the processor 23) generates the order receipt information which is linked to the contract information by inputting the same order ID as the contract information in the order receipt information. The order reception terminal 20 provides the order receipt information by, for example, storing the order receipt information in the predetermined storage destination (for example, the distributed ledger D). For example, the processor 23 controls the transmission/reception unit 22 and causes the transmission/reception unit 22 to execute transmission of the order receipt information and an instruction to store the order receipt information.

The distributed ledger D receives, for example, the order receipt information and the instruction transmitted by the transmission/reception unit 22, and stores the order receipt information in accordance with the instruction. The distributed ledger D stores the order receipt information such that the order receipt information is linked to the corresponding contract information. When the order receipt information is received, the distributed ledger D notifies the order placement terminal 10, which is the provision source of the contract information linked to the order receipt information, about the reception of the order receipt information. Upon receiving a request from the order placement terminal 10 in response to the notification about the reception of the order receipt information, the distributed ledger D provides the order receipt information to the order placement terminal 10. The distributed ledger D may transmit the order receipt information to the provision source of the contract information to notify the order placement terminal 10 about the reception of the order receipt information. Alternatively, the order reception terminal 20 may not transmit the order receipt information to the distributed ledger D, but instead transmit the order receipt information to, for example, the order placement terminal 10.

The reception unit 21 of the order reception terminal 20 receives an input (to be referred to as an “operation for completion” as appropriate) instructing the generation of the completion information. For example, the order reception terminal 20 may include a camera, and the operation for completion may include inputting an instruction to cause the camera to capture an image showing the completion of the job. Assume that a job specified in the contract information is, for example, a job of delivering goods. A worker operates the reception unit 21 to capture, as the image showing the completion of the job, an image of the goods deposited at the destination of shipment or an image of the receipt of the goods. The processor 23 generates the completion information by using the information acquired from the image captured by the operation for completion.

The completion information may include at least a part of the data of the image captured by the operation for completion, or include data acquired by processing the image captured by the operation for completion. In the following description, an entity that receives goods, information, or a service through a job specified in the contract information will be referred to as a recipient. The aforementioned image may be, for example, an image of a document issued by the recipient. This document may be a receipt with a seal of receipt stamped thereon. The processor 23 may perform image processing to identify the seal of receipt, and generate the completion information which includes information (for example, a flag) indicating that the seal of receipt is present. The order reception terminal 20 may also store information about the proof of job completion in a predetermined storage unit, and include information (for example, a URL) indicating the location of the stored information in the completion information.

Note that proof indicating the completion of the job (to be referred to as “proof of job completion” as appropriate) may include information in a format different from an image. For example, electronic data such as a code indicating job completion may be issued at the delivery destination, and the processor 23 may generate completion information which includes this electronic data. The order reception terminal 20 may also include a touchpad, and the proof of job completion may include a signature input by the recipient via the touchpad. The proof of job completion may also include biometric information such as the fingerprint, the pattern of the retina, or the pattern of the veins of the recipient. A device for reading the recipient's biometric information may be included in the order reception terminal 20 or may be provided outside of the order reception terminal 20.

The order reception terminal 20 provides the completion information such that the completion information is linked to the contract information. For example, since the contract information includes the order ID, including the same order ID as the order ID of the contract information in the completion information allows the completion information to be linked to the contract information. The order reception terminal 20 (for example, the processor 23) can input the same order ID as that of the contract information in the completion information to generate the completion information which is linked to the contract information. For example, the order reception terminal 20 provides the completion information by storing the completion information in a predetermined storage destination (for example, the distributed ledger D). The processor 23 includes a storage controller 24. The storage controller 24 stores the completion information in the predetermined storage destination. For example, the storage controller 24 controls the transmission/reception unit 22 so as to cause the transmission/reception unit 22 to execute the transmission of the completion information and an instruction to store the completion information. The distributed ledger D receives, for example, the completion information and the instruction transmitted from the transmission/reception unit 22, and stores the completion information in accordance with the instruction. The distributed ledger D stores the completion information such that the completion confirmation information is linked to the corresponding contract information.

When the completion information is received, the distributed ledger D notifies the order placement terminal 10, which is the provision source of the contract information linked to the completion information, about the reception of the completion information. The distributed ledger D provides, in response to a request from the order placement terminal 10, the completion information to the order placement terminal 10. Upon receiving the notification that the distributed ledger D has received the completion information, the order placement terminal 10 requests the distributed ledger D to transmit the completion information. The distributed ledger D may transmit the completion information to the provision source of the contract information to give notice of the reception of the completion information. Note that the distributed ledger D may not transmit the completion information to the order placement terminal 10, as the provision source of the contract information to be linked to the completion information, to give notice of the reception of the completion information. The order placement terminal 10 may, for example, periodically or aperiodically detect whether the completion information is stored in the distributed ledger D.

The remittance terminal 30 executes remittance processing for remitting the payment for the job specified in the contract information. The remittance processing includes, for example, a process of specifying the account of the payer of the payment, a process of specifying the account of the payee of the payment, and a process of transferring value corresponding to the payment indicated in the contract information from the specified account of the payer to the specified account of the payee.

Information (to be referred to as “payer information” as appropriate) indicating the account of the payer of the payment includes, for example, the order placing entity's account number at a financial institution. The payer information is linked to an order placing entity ID. The payer information may be included in information (for example, the contract information) which includes the order placing entity ID. The payer information may be stored in advance in a predetermined storage unit (for example, distributed ledger D), or may be provided from the order placement terminal 10 at the time of the remittance processing. Information (to be referred to as “payee information” as appropriate) indicating the account of the payee of the payment includes, for example, the order receiving entity's account number at a financial institution. The payee information linked to an order receiving entity ID. The payee information may be included in information (for example, the completion information) which includes the order receiving entity ID. The payee information may be stored in advance in a predetermined storage unit (for example, the distributed ledger D) or may be provided from the order reception terminal 20 at the time of the remittance processing. The payment may be expressed in legal tender, cryptocurrency, or in points which can be exchanged into legal tender or cryptocurrency.

When the information (for example, the completion confirmation information) which is to trigger the remittance processing is provided from the order placement terminal 10, the remittance terminal 30 executes the remittance processing. For example, the remittance terminal 30 executes the remittance processing when the information (for example, the completion confirmation information) which is to trigger the remittance processing is stored in the distributed ledger D. When the completion confirmation information is stored, the distributed ledger D notifies the remittance terminal 30 about the provision of the completion confirmation information. When the notification about the provision of the completion confirmation information is received from the distributed ledger D, the remittance terminal 30 acquires the order placing entity ID from the information (for example, the contract information) linked to the completion confirmation information. Subsequently, the remittance terminal 30 specifies the payer information linked to the acquired order placing entity ID. The remittance terminal 30 also acquires the order receiving entity ID from the information (for example, the completion information) which is linked to the completion confirmation information and includes the order receiving entity ID. Subsequently, the remittance terminal 30 specifies the payee information linked to the acquired order receiving entity ID. The remittance terminal 30 also specifies the information about the payment from the contract information linked to the completion confirmation information. The remittance terminal 30 uses the payer information, the payee information, and the payment information, which are specified in the above-described manner, to execute the remittance processing.

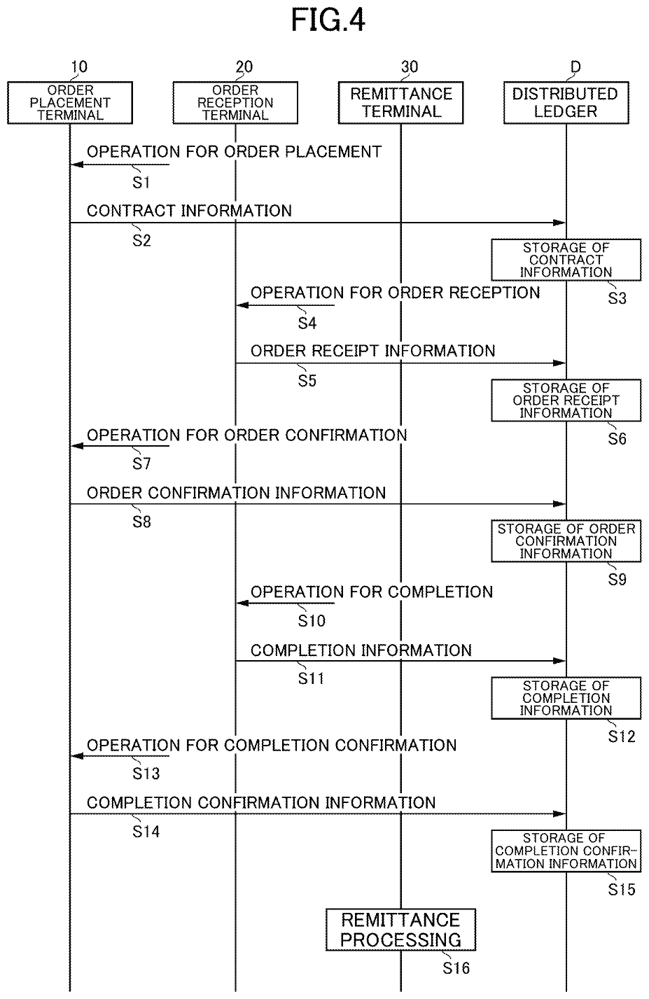

A payment remittance support method according to the embodiment will be described next based on the configuration of the payment remittance support system 1 illustrated in FIG. 3. The payment remittance support method according to the embodiment can be executed by, for example, the various types of processing of the payment remittance support system 1. FIG. 4 is a sequence diagram illustrating processing by the payment remittance support system according to the embodiment. Each unit of the payment remittance support system 1 will be described with reference to FIG. 3 as appropriate.

A description will be given here by assuming that the job for which an order is placed/accepted is a job of delivering goods. A job for which an order is placed/accepted is not limited to a job of delivering goods, and may include jobs in construction, clerical work, cleaning, sales, manufacturing, maintenance, and other various types of services. A job according to the embodiment may also be referred to as a duty, a process, a task, or work.

The order placement terminal 10 receives, in step S1, an operation for order placement from an order placing entity. For example, the order placement terminal 10 receives inputs of order placement information including the contents of a contract of a job for which an order is placed. The contents of the contract includes, for example, the dates and times related to the job, the contents of the job, and the information about the payment of the job. The dates and times related to the job includes, for example, one of or both the start date and time of the job and the end date and time of the job. The contents of the job includes, for example, information about a target object of the job and information about the process to be performed on the target object. Information about the target object includes, for example, at least one of the type, the size, the weight, and the amount of cargo to be delivered. The information about the process of the job includes, for example, information about the location of the origin of shipment and the information about the location of the destination of the shipment. The contents of the job may include, for example, other pieces of information such as a condition for the process. The condition for the process may include, for example, at least one of a restriction on the temperature of the environment in which the cargo will be placed during the delivery (for example, whether to be shipped refrigerated, frozen, or room temperature), a restriction on impact toward cargo during delivery (for example, a fragile item label), and a restriction on the orientation of the cargo during delivery (for example, a “This Side Up” label or a “Do Not Stack” label). Note that the contents of contract may not include at least one of the dates and times related to the job, the contents of the job, and the information about the payment for the job. For example, the dates and times related to the job, the contents of the job, and the information about the payment for the job may be defined in advance so that the order placing entity need not input these pieces of information.

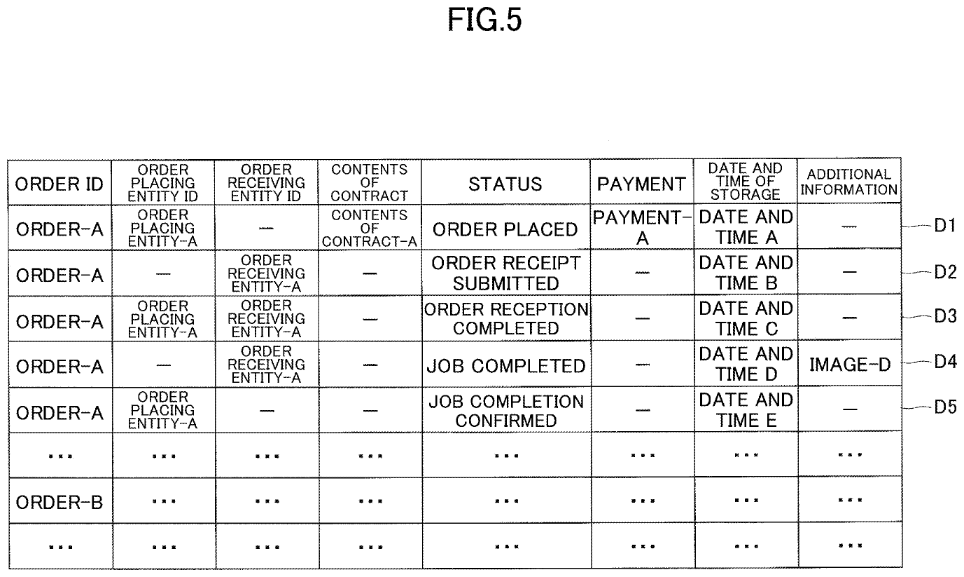

In step S2, the order placement terminal 10 provides the contract information. For example, the order placement terminal 10 provides the contract information to the outside of the order placement terminal 10 by storing the contract information in a predetermined storage destination (for example, distributed ledger D). For example, the order placement terminal 10 transmits the contract information and the instruction to store the contract information by setting the terminals 40 (see FIG. 1) forming the distributed ledger D as the destination. When the contract information and the instruction are received, the distributed ledger D stores the contract information in accordance with the instruction. The distributed ledger D stores, for example, contract information D1 illustrated in FIG. 5 to be described later.

FIG. 5 is a table illustrating an example of information stored in the distributed ledger according to the embodiment. In FIG. 5, various types of information are illustrated in a table format. The row of reference number D1 is the contract information, the row of reference number D2 is the order receipt information, the row of reference number D3 is the order confirmation information, the row of reference number D4 is the completion information, and the row of reference number D5 is the completion confirmation information. In the example of FIG. 5, each piece of information includes, as items, an order ID, an order placing entity ID, an order receiving entity ID, contents of a contract, status, a payment, a date and time of storage, and additional information. Note that “-” indicates that data is not included (for example, NULL) in FIG. 5.

The item for an order ID corresponds to the identification information assigned to each contract. The order IDs are assigned so as to avoid duplication of order IDs when a plurality of contracts are present. The order ID is a piece of information used to distinguish one contract from another contract. Each of the order receipt information D2, the order confirmation information D3, completion information D4, and the completion confirmation information D5 in FIG. 5 is a piece of information linked to the contract information D1. The order receipt information D2, the order confirmation information D3, completion information D4, and the completion confirmation information D5 each include the same order ID (“ORDER-A” in FIG. 5) as the contract information D1, thereby allowing linkage to the contract information D1.

The order ID is generated by, for example, the order placement terminal 10. The order placement terminal 10 generates the order ID based on, for example, the crypto address of the order placing entity's wallet and the time (for example, the time of the order placement) at which the contract information is generated. The order ID may be generated by another method or may be generated by a different device from the order placement terminal 10.

The item for an order placing entity ID corresponds to the identification information for an order placing entity. The order placing entity ID may include, for example, the crypto address of the order placing entity's wallet, a piece of unique information (hash value) generated from this crypto address, or other pieces of information. The order receiving entity ID is the identification information for the order receiving entity. The order receiving entity ID may include, for example, the crypto address of the order receiving entity's wallet, a piece of unique information (hash value) generated from this crypto address, or other pieces of information.

The item for status corresponds to the status of the ordered job. For example, “STATUS” in the contract information D1 is “ORDER PLACED” indicating that an order has been placed by the order placing entity. The “STATUS” in the order receipt information D2 is “ORDER RECEIPT SUBMITTED” indicating that the order receiving entity has submitted (applied for) an order receipt. The “STATUS” in the order confirmation information D3 is “ORDER RECEPTION COMPLETED” indicating that the order placing entity has approved the submission of the order receipt. The “STATUS” in the completion information D4 is “JOB COMPLETED” indicating that the job has been completed by the order receiving entity. The “STATUS” in the completion confirmation information D5 is “JOB COMPLETION CONFIRMED” indicating that the completion of the job has been confirmed by the order placing entity.

The item for a payment corresponds to a payment remitted to the order receiving entity for the execution of the job. The item for the date and time of storage corresponds to the date and time at which each piece of information was stored in the distributed ledger D. The item for additional information corresponds to additional information related to the job or the like. A piece of additional information includes, for example, information about the proof indicating the completion of the job. Note that the various types of information in FIG. 3 are illustrated individually, and information obtained by combining these information as a set can be used as information that indicates the history of the job from the order placement to the confirmation of completion. At least one of these pieces of information may be overwritten on another piece of information. For example, the contract information D1 may be updated to the contract information which includes the order receipt information D2 by overwriting the contract information D1 with the information (for example, the order receiving entity ID, the status, and the date and time of storage) included in the order receipt information D2.

The description returns to FIGS. 3 and 4. In step S3, the distributed ledger D stores, for example, the contract information D1 illustrated in FIG. 5. In step S4, the order reception terminal 20 receives the operation for order reception from the order receiving entity. Before the process of step S4, the order reception terminal 20 may execute processing to search for the contract information for which an order receipt can be submitted from the distributed ledger D. Order receipt submission is a process to inform the order placing entity of the intention to receive/accept the order. For example, the order reception terminal 20 may determine that each piece of contract information whose item for status indicates “ORDER PLACED”, among the pieces of contract information stored in the distributed ledger D, is a piece of contract information for which an order receipt can be submitted. The order reception terminal 20 may execute such search processing in response to an operation by the order receiving entity or may automatically execute such search processing periodically or aperiodically. In the above-described search processing, the order reception terminal 20 may extract the contract information which matches a condition designated by the order receiving entity. A condition that can be designated in the search processing is a condition with respect to at least one item of information included in the contract information, and includes, for example, at least one of the conditions among a carry-in date and time, a carry-in location, a carry-out location, a carry-out date and time, and payment.

The order reception terminal 20 may output the contract information extracted from the search processing. For example, the order reception terminal 20 may display a list of the outline of pieces of contract information extracted from the search processing. The order reception terminal 20 may receive, from the order receiving entity, an input to select a piece of contract information from the list. When an input selecting a piece of contract information from the list is received, the order reception terminal 20 may display the contract information corresponding to this input in a mode with a larger amount of information than the list.

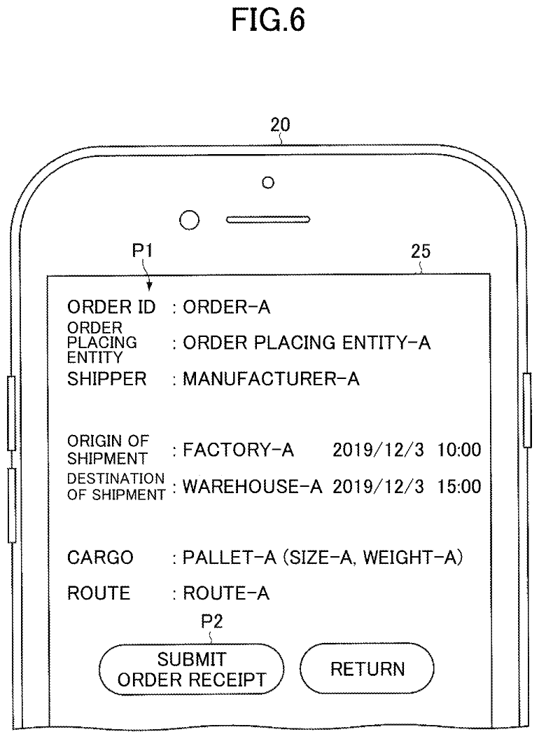

FIG. 6 is a view illustrating an example of an image which is displayed on the order reception terminal according to the embodiment. The order reception terminal 20 in FIG. 6 is a smartphone. The order reception terminal 20 includes the display unit 25 and a transparent touchpad overlaid on the display unit 25. The display unit 25 and the touchpad form a touch panel, and the order receiving entity can input various types of information by touching a graphical user interface image (to be referred to as a GUI image as appropriate) displayed on the display unit 25.

Reference number P1 in FIG. 6 indicates an example of an image displayed on the display unit 25. The image P1 includes a text expressing at least a part of the contract information. For example, the image P1 includes texts expressing ORDER-A as the order ID, and ORDER PLACEMENT ENTITY-A as the order placing entity, and MANUFACTURER-A as the shipper. The image P1 also includes texts expressing ORIGIN OF SHIPMENT, DESTINATION OF SHIPMENT, CARGO, and ROUTE corresponding to the contents of the contract. In FIG. 6, ORIGIN OF SHIPMENT indicates the start of the delivery, and it is FACTORY-A in this case. Also, 2019/12/3 10:00 displayed side by side with FACTORY-A is the date and time of the start of the delivery that has been specified as the dates and times of the job. DESTINATION OF SHIPMENT is the terminus of the delivery, and it is WAREHOUSE-A in this case. 2019/12/3 15:00 displayed side by side with WAREHOUSE-A is the date and time of the completion of the delivery that has been specified as the dates and times of the job. CARGO is the target being delivered, and it is PALETTE-A in this case. Furthermore, SIZE-A and WEIGHT-A are pieces of information about the details of PALETTE-A. ROUTE is the designated or recommended route, and it is ROUTE-A in this case. In FIG. 6, the order reception terminal 20 displays a GUI image for receiving inputs about accepting the order on the display unit 25. The GUI image includes, for example, an icon P2 indicating “SUBMIT ORDER RECEIPT”. When it is detected that the order receiving entity has touched an icon 27, the order reception terminal 20 determines that an operation for order reception has been performed.

Returning to FIG. 4, the order reception terminal 20 provides the order receipt information in step S5. For example, the order reception terminal 20 provides the order receipt information to the outside of the order reception terminal 20 by storing the order receipt information in a predetermined storage destination (for example, distributed ledger D). The order reception terminal 20 transmits the order receipt information and an instruction to store the order receipt information to, for example, the terminals forming the distributed ledger D as the destination. When the order receipt information and the instruction are received, the distributed ledger D stores the order receipt information in accordance with the instruction in step S6. The distributed ledger D stores, for example, the order receipt information D2 illustrated in FIG. 5.

The order placement terminal 10 receives, in step S7, operation for order confirmation from the order placing entity. For example, the order placement terminal 10 displays information indicating that the order receiving entity-A has submitted an order receipt for the order-A. The order placement terminal 10 receives an operation from the order placing entity with respect to this submitted order receipt. The order placement terminal 10 generates the order confirmation information based on the received operation. For example, when it is determined that an input indicating the approval of the order reception has been received for the submitted order receipt, the order placement terminal 10 generates the order confirmation information indicating the approval of the order reception.

In step S8, the order placement terminal 10 provides the order confirmation information. For example, the order placement terminal 10 provides the order confirmation information to the outside of the order placement terminal 10 by storing the order confirmation information to the predetermined storage destination (for example, the distributed ledger D). The order placement terminal 10 transmits the order confirmation information and an instruction to store the order confirmation information to, for example, the terminals forming the distributed ledger D as the destination. When the order confirmation information and the instruction are received, the distributed ledger D stores the order confirmation information in accordance with the instruction in step S9. The distributed ledger D stores, for example, the order confirmation information D3 illustrated in FIG. 5. The order receiving entity confirms through, for example, the order confirmation information D3 that the contract has been established and executes the job specified in the contract information. The order reception terminal 20 receives, in step S10, an operation for completion from the order receiving entity. When it is determined that the operation for completion has been received, the order reception terminal 20 generates the completion information. The completion information includes information indicating that the job has been executed by the order receiving entity.

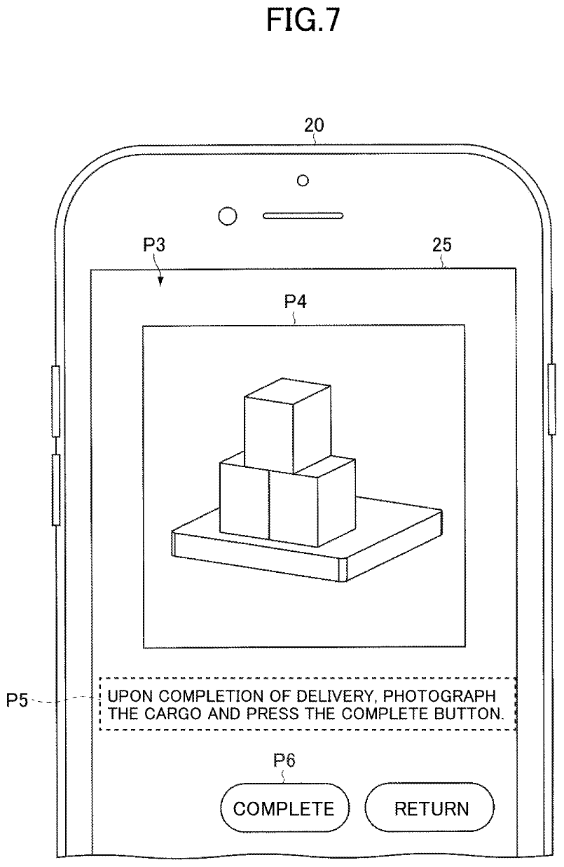

FIG. 7 is a view illustrating an example of an image displayed on the order reception terminal according to the embodiment. For example, an application for performing a process of reporting the completion of the job is installed in advance in the order reception terminal 20. This application displays an image P3 on the display unit 25 when activated. In the example of FIG. 7, the image P3 includes information P4 indicating proof of job completion, information P5 indicating guidance for the operation for completion, and an area P6 where an icon for receiving the operation for completion is provided.

For example, an image of the delivery-target cargo placed at the destination of shipment that has been captured by the camera of the order reception terminal 20 is provided in the area P4. The order reception terminal 20 displays an image selected by the worker who is operating the terminal. Note that the order reception terminal 20 may display a preview image of the camera in the area P4. The order reception terminal 20 may cause the camera to execute image capturing when the worker has touched the area P4. When it is detected that, for example, the area P6 where a “COMPLETE” icon is provided has been touched, the order reception terminal 20 determines that that the operation for completion has been performed. When it is determined that the operation for completion has been performed, the order reception terminal 20 generates the completion information. Note that when a preview image of the camera is displayed in the area P4 and it is determined that the operation for completion has been performed, the order reception terminal 20 may cause the camera to execute image capturing and generate the completion information based on the data of the image obtained by the image capturing.

Note that the information about proof of job completion is not limited to that in the example of FIG. 7, and may include an image of a receipt issued at the destination of shipment. In addition, the information about proof of job completion may include information which the order reception terminal 20 acquired by scanning a code pattern. The code pattern includes, for example, a 1D code such as a barcode, a 2D code such as a QR code®, or a pattern which has a function equivalent to these codes. The code pattern may be provided, for example, at the facility (the destination of shipment) of the recipient or may be printed on a document (for example, a receipt) issued by the recipient. The code pattern may also be issued by the terminal (for example, a smartphone) of the recipient, and may be displayed on a display unit of the terminal of the recipient.

Note that the image of the proof may include metadata in an exchangeable image file format (Exif) or the like. This metadata may include one of or both pieces of information about the location and the date and time at which the image was captured. For example, the order reception terminal 20 may use a satellite measuring system such as the global positioning system (GPS) or the like to acquire position information about its own device position when the camera of the order reception terminal 20 captures an image. This position information can be used to generate the metadata.

Note that the proof of job completion may include information may include information in a format different from an image. For example, the proof of job completion may include electronic data transmitted from the terminal of the recipient. Assume here that the recipient is a purchaser who has purchased a product from an e-commerce website, the order placing entity has ordered the delivery of this product, and the order receiving entity has accepted the order for the delivery. The e-commerce website issues a code to the purchaser when the purchase of the product is received, and conceals this code from the order placing entity and the order receiving entity. The order receiving entity may receive the code as the information about proof of job completion from the recipient who is the purchaser. The code may be transmitted from the terminal of the recipient to the order reception terminal 20. The terminal of the recipient may display a code pattern including the code, and the order reception terminal 20 may scan the code pattern displayed on the terminal of the recipient to acquire the code. For example, the proof of job completion may include one of or both a signature input on the touch panel of the order reception terminal 20 and biometric information about the recipient read by a biometric authentication device.

Returning to FIG. 4, the order reception terminal 20 provides the completion information in step S11. For example, the order reception terminal 20 provides the completion information to the outside of the order reception terminal 20 by storing the completion information in a predetermined storage destination (for example, the distributed ledger D). For example, the storage controller 24 of the order reception terminal 20 controls the transmission/reception unit 22 and causes the transmission/reception unit 22 to execute the transmission of the completion information and an instruction to store the completion information. When the completion information and the instruction are received, the distributed ledger D stores the completion information in accordance with the instruction in step S12. As a result, for example, in the completion information D4 illustrated in FIG. 5, “JOB COMPLETED” is stored in the item for “STATUS”, “DATE AND TIME D” is stored in the item for “DATE AND TIME OF STORAGE”, and “IMAGE-D” as the information about the proof of job completion is stored in the item for “ADDITIONAL INFORMATION”.

The order placement terminal 10 receives, in step S13, an operation for completion confirmation of the job from the order placing entity. For example, the order placement terminal 10 acquires the completion information form the distributed ledger D and displays the completion information. The order placing entity confirms, for example, the information about the proof of job completion included in the completion information, and inputs, into the order placement terminal 10, information indicating that the job completion has been confirmed. When it is determined that the operation for completion confirmation of the job has been received, the order placement terminal 10 generates the completion confirmation information.

In step S14, the order placement terminal 10 provides the completion confirmation information. The remittance unit 15 of the order placement terminal 10 provides the completion confirmation information as the information to trigger the remittance processing. For example, the order placement terminal 10 provides the completion confirmation information to the outside of the order placement terminal 10 by storing the completion confirmation information in a predetermined storage destination (for example, the distributed ledger D). For example, the order placement terminal 10 transmits the contract information and an instruction to store the contract information to the terminals 40 (see FIG. 1) forming the distributed ledger D as the destination. When the contract information and the instruction are received, the distributed ledger D stores the contract information in accordance with the instruction in step S15. The distributed ledger D stores, for example, the completion confirmation information D5 illustrated in FIG. 5.

When the information to trigger the execution of the remittance processing is provided, the remittance terminal 30 executes the remittance processing in step S16. When the completion confirmation information is stored in the distributed ledger D, the remittance terminal 30 executes, for example, the remittance processing. For example, the remittance terminal 30 specifies the account of the payer based on the information (for example, the contract information) linked to the completion confirmation information. The remittance terminal 30 also specifies the account of the payee based on the information (for example, the completion information) linked to the completion confirmation information. Further, the remittance terminal 30 species the value of the payment based on the contract information which is linked to the completion confirmation information. The remittance terminal 30 executes processing to transfer the specified value of payment from the specified account of the payer to the specified account of the payee.

In the above-described embodiment, the order placement terminal 10 provides the contract information which indicates the contents of a job to be ordered and the payment for the job. The order reception terminal 20 provides the completion information, which indicates the completion of the job whose order was accepted, such that the completion information is linked to the contract information. The remittance unit 15 causes the remittance processing for the payment indicated in the contract information, which is linked to the completion information, to be executed. In this type of payment remittance support system 1, the remittance processing for the payment indicated in the contract information, which is linked to the completion information, is executed based on the completion information. Therefore, for example, the remittance of the payment can be executed smoothly, and the convenience and the immediacy of order placement and order reception can be improved.

The payment remittance support system according to the embodiment includes an order placement terminal for providing the contract information which indicates the contents of a job to be ordered and the payment for the job; an order reception terminal for providing the completion information, which indicates the completion of the job whose order was accepted, such that the completion information is linked to the contract information; and a remittance unit for executing the remittance processing for the payment indicated in the contract information which is linked to the completion information. The remittance unit is, for example, arranged in the order placement terminal, but may be arranged in a different terminal from the order placement terminal. The payment remittance support system includes, for example, a remittance terminal, but may not include the remittance terminal.

In this embodiment, the order placement terminal provides the contract information by storing the contract information in a distributed ledger. The remittance unit executes the remittance processing based on the contract information stored in the distributed ledger. The order placement terminal may store the contract information in a different storage destination from the distributed ledger, and may not store the contract information in the distributed ledger. The order placement terminal may provide the contract information by transmitting the contract information to its provision destination (for example, the order reception terminal) as the destination.

In this embodiment, the order placement terminal includes the remittance unit. Based on the contract information provided to the order placement terminal, the remittance unit provides the completion confirmation information, which indicates that the completion of the job has been confirmed, such that the completion confirmation information is linked to the contract information. The remittance processing is executed by the remittance terminal which receives the completion confirmation information. The remittance unit may be arranged in a different terminal (for example, the remittance terminal) from the order placement terminal. The remittance unit may not provide the completion confirmation information. In such a case, the remittance processing may be executed based on a different piece of information (for example, an instruction to execute the remittance processing) from the completion confirmation information.

In this embodiment, the order reception terminal provides the contract information by storing the contract information in the distributed ledger. The remittance unit executes the remittance processing when the completion of the job is confirmed based on the completion information stored in the distributed ledger. The order reception terminal may store the contract information in a different storage destination from the distributed ledger, and may not store the completion information in the distributed ledger. The order reception terminal may provide the completion information by transmitting the completion information to its provision destination (for example, the order placement terminal) as the destination. The remittance unit may execute the remittance processing based on the completion information which is stored in the different storage destination from the distributed ledger.

In this embodiment, the information indicating the account of the payer of the payment is provided such that the information is linked to the contract information, and the remittance processing includes a process of specifying the account of the payer by using the contract information which is linked to the completion information. The information indicating the account of the payer may be provided separately from the contract information. The remittance unit may execute the remittance processing by designating the account of the payer.

In this embodiment, the information indicating the account of the payee of the payment is provided such that the information is linked to the contract information, and the remittance processing includes a process of specifying the account of the payee by using the contract information which is linked to the completion confirmation information. The information indicating the account of the payee may be provided separately from the contract information. The remittance terminal may execute the remittance processing based on the information the account of the payee provided from the order reception terminal.

In this embodiment, the contract information includes the identification information. The completion information includes the identification information and the information about the proof of the job completion, and is linked to the contract information by the identification information. The contract information may not include the identification information. The contract information and the completion information may be linked by a different piece of information from the identification information, and may be linked by being expressed by a single file.

The payment remittance support method according to this embodiment includes providing, by the order placement terminal, the contract information indicating a payment for and contents of a job to be ordered; linking the completion information, which indicates the completion of the job whose order was accepted, to the contract information and providing, by an order reception terminal, the completion information; and executing the remittance processing for the payment indicated in the contract information which is linked to the completion information. However, the payment remittance support method may also include other processes.

In this embodiment, the order reception terminal includes a computer, and a program stored in a storage unit of the order reception terminal causes the computer to execute the remittance processing for the payment based on the contract information, which indicates the contents of a job to be ordered and the payment for the job, and the completion information which is linked to the contract information and indicates the completion of the job whose order was accepted. The program may be stored in a storage unit of a different terminal from the order reception terminal. The program may be stored in and provided from a computer-readable storage medium.

Note that the storage destination of various types of information describe above may be a storage unit of a different device from the terminals forming the distributed ledger D. The various types of information includes, for example, at least one of the contract information, the order receipt information, the order confirmation information, the completion information, the information about the proof of job completion, and the completion confirmation information. The terminals for providing the various types of information may notify a terminal linked to the various types of information about the provision of the various types of information. This notification may be a preliminary notification issued before the provision of the various types of information or may be a completion notification issued after the provision of the various types of information. For example, after providing the completion information, the order reception terminal 20 may notify the order placement terminal 10, which is the provision source of the contract information linked to the completion information, about the provision of the completion information (for example, the storage of the completion information in the distributed ledger D). A first terminal (for example, the order placement terminal 10), included in the payment remittance support system 1, may not notify a second terminal (the order reception terminal 20), included in the payment remittance support system 1, about the provision of the various types of information.

Note that after the various types of information are stored in the distributed ledger D, the terminals forming the forming the distributed ledger D may notify a terminal linked to the information about the provision of the information. For example, after a completion report is stored in the distributed ledger D, the terminals forming the distributed ledger D may notify the order placement terminal 10, which is the provision source of the contract information linked to the completion information, about the provision of the completion information. The terminals forming the distributed ledger D may also not notify the terminal included in the payment remittance support system about the provision of the various types of information.

Note that the terminal (for example, the order placement terminal 10) included in the payment remittance support system 1 may detect whether the various types of information are stored in a predetermined storage destination. For example, the order placement terminal 10 may search for the information stored in the distributed ledger D periodically or at an aperiodic discretionary timing to determine whether the desired information is stored in the distributed ledger D. The terminal included in the payment remittance support system 1 may also not detect whether the various types of information are stored in the predetermined storage destination.

Note that the terminal (for example, the order placement terminal 10) included in the payment remittance support system 1 may use the completion information to determine whether the job indicated in the contract information has been completed. For example, in a case where the credibility of the proof included in the completion information has been ensured, the order placement terminal 10 may determine that the job indicated in the contract information has been completed. The proof may include, for example, information (to be referred to as “receipt information” as appropriate) issued by a recipient who receives goods, information, or a service from the job specified in the contract information. The receipt information includes, for example, a digital signature, a code, or a flag, and is assumed be information whose credibility is ensured since it is information issued by the recipient. For example, the order placement terminal 10 provides a code specifying the job to the recipient, and conceals this code from the order receiving entity. The recipient can use the code as a piece of receipt information and provide the code to the order receiving entity after the completion of the job corresponding to the code. The order reception terminal 20 includes the code, which is provided from the recipient, in the completion information. When the aforementioned code is included in the completion information, the order placement terminal 10 determines that the job indicated in the contract information has been completed. When it is determined that the job indicated in the contract information has been completed, the order placement terminal 10 may generate the completion confirmation information automatically.

Note that the terminal (for example, the order placement terminal 10) included in the payment remittance support system 1 may evaluate the credibility of the information about the proof of job completion included in the completion information. The order placement terminal 10 may verify or audit the information about the proof of job completion. For example, assume that the information about the proof of job completion includes data of an image capturing a receipt with a seal of receipt stamped thereon. In this case, when it is determined that the seal of receipt captured in the image matches a seal of receipt which has been registered in advance, the order placement terminal 10 may determine that the completion confirmation of the job has been completed. Alternatively, assume that the information about the proof of job completion includes information about a position where the proof of job completion has been acquired. In this case, the order placement terminal 10 may compare the information about the location (for example, the position of the destination of shipment) of the job included in the contract information linked to the completion information and the information about the position included in the information about the proof of job completion. When it is determined that the both positions match, the order placement terminal 10 may determine that the job has been completed. Alternatively, assume that the information about the proof of job completion includes data of an image capturing the cargo which has been deposited at the destination of shipment. The order placement terminal 10 may recognize the image by, for example, artificial intelligence (AI) using machine learning such as deep learning to specify the cargo and the location captured in the image.

The order placement terminal 10 may also confirm the completion of the job based on the location of the specified cargo and other pieces of information (for example, the date and time). For example, when it is determined that the cargo recognized from the image matches the delivery-target cargo included in the contract information, the image capturing location added to the image of the proof of job completion matches the location of the destination of shipment included in the contract information, and the date and time of image capturing added to the image of the proof of job completion matches the condition of the date and time included in the contract information, the order placement terminal 10 may determine that the job has been completed. By displaying the result of the evaluation on the credibility of the information about the proof of job completion which is performed in the above described manner and receiving an operation for completion, the order placement terminal 10 may execute processing for supporting the confirmation of job completion.

In the above description, at least some of the processes executed by the order placement terminal 10 may be executed by a different terminal from the order placement terminal 10. In the above description, at least some of the processes executed by the order reception terminal 20 may be executed by a different terminal from the order reception terminal 20. In the above description, at least some of the processes executed by the remittance terminal 30 may be executed by a different terminal from the remittance terminal 30. At least some of the functional units of the order placement terminal 10, the order reception terminal 20, and the remittance terminal 30 may be implemented by cloud computing provided by one or more computers.

Note that when the order reception terminal 20 has provided the completion information, the remittance terminal 30 may receive the operation for completion confirmation instead of the order placement terminal 10. In this case, the order reception terminal 20 may determine whether to execute the remittance processing based on the received operation for completion confirmation. Furthermore, the remittance terminal 30 may use the completion information to determine whether the job indicated in the contract information has been completed. When it is determined that the job indicated in the contract information has been completed, the remittance terminal 30 may execute the remittance processing.

Note that the remittance terminal 30 may execute the remittance processing based on a different piece of information from the completion confirmation information. For example, the order placement terminal 10 may provide, as the different piece of information from the completion confirmation information, an instruction to execute the remittance processing. The remittance terminal 30 may execute the remittance processing by receiving this instruction. In this case, the remittance terminal 30 may not be notified about the provision of the completion confirmation information. Furthermore, the remittance terminal 30 may neither provide the completion confirmation information nor generate the completion confirmation information.

Note that the remittance terminal 30 may remit the payment, which is designated by the order placement terminal 10, to the order receiving entity designated by the order placement terminal 10. In this case, when an operation for completion confirmation is received for the job, the order placement terminal 10 may refer to the contract information included in the order placement information about the order-A stored in the distributed ledger D, and transmit, to the remittance terminal 30, a request to remit the payment stored in the contract information from the order placing entity-A to the order receiving entity-A. The request may include the information about the order-A which is the order ID of the remittance target.

Note that the remittance terminal 30 may execute the remittance processing upon loaning value to the account of the payer. In this case, the remittance terminal 30 may collect a predetermined commission corresponding to the loaned amount from the order placing entity or the account of the payer on a predetermined settlement date. The remittance terminal 30 may also collect a payment (for example, a commission) for executing the remittance processing from the order placing entity or the account of the payer. It may also be possible to select a remittance method for payment in the payment remittance support system 1. For example, the payment remittance support system 1 may receive a designation of the remittance method from the order receiving entity, and may provide an instruction to execute the remittance processing to a terminal which is to execute the remittance processing by the designated remittance method.

### Second Embodiment

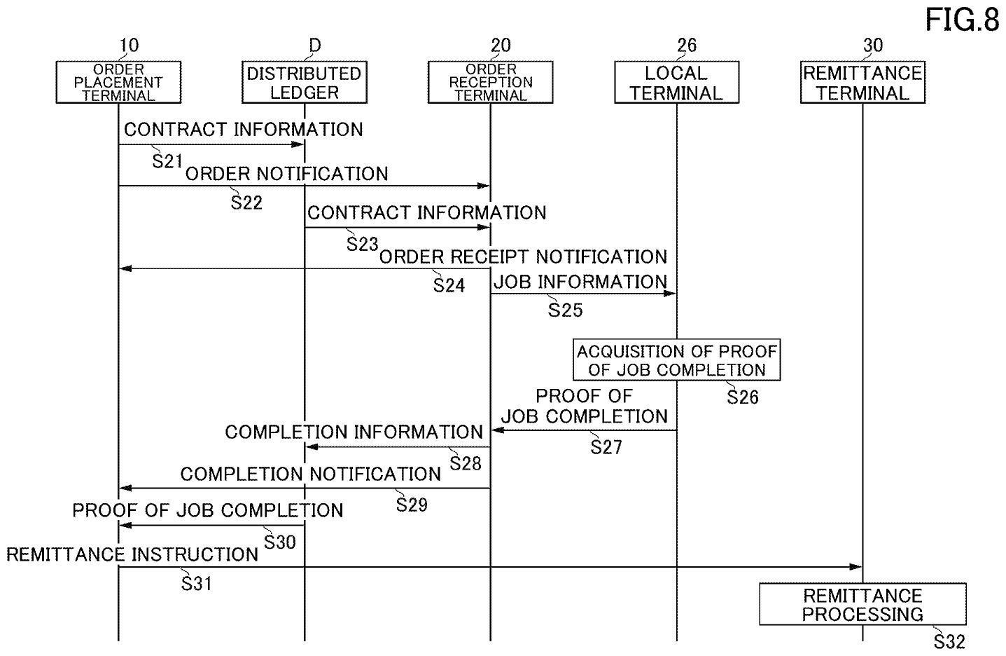

The second embodiment will be described. In this embodiment, the same reference numbers denote components similar to those of the embodiment described above, and a description thereof will be omitted or simplified. FIG. 8 is a sequence diagram illustrating processing by a payment remittance support system according to this embodiment.

The payment remittance support system according to the embodiment includes a local terminal 26. The local terminal 26 is a terminal used at a location (to be referred to as a “local site” as appropriate) where the job indicated in the contract information is performed. For example, the local terminal 26 is a terminal operated by a worker who is to execute the job indicated in the contract information. Although the local terminal 26 may have configuration similar to, for example, the configuration of an order placement terminal 10 illustrated in FIG. 2, the configuration of the local terminal 26 may be different from the configuration of the order placement terminal 10. An order reception terminal 20 and the local terminal 26 form an order reception system. The order reception system executes processing for accepting the order of the job indicated in the contract information and processing for job completion notification.

The local terminal 26 is, for example, a portable terminal such as a smartphone, a tablet, or a laptop. The worker may take the local terminal 26 to the local site and execute the job. The local terminal 26 receives, for example, information related to the contents of the job from the order reception terminal 20. For example, the worker operates the local terminal 26 to acquire the information related to the contents of the job, and performs the job after confirming this information. The local terminal 26 acquires, for example, information (for example, information about proof of job completion) related to the elapse or the completion of the job, and provides the information to the order reception terminal 20.

Note that the local terminal 26 may be a terminal used by a recipient who is to receive goods, information or a service from the job specified in the contract information. For example, when the job specified in the contract information has been completed, the local terminal 26 may acquire or issue information (for example, the information about proof of job completion) indicating the completion of the job. For example, assume that the aforementioned job is a job of delivering cargo. The local terminal 26 may include a camera and may use this camera to capture a bill attached to the delivered cargo. The local terminal 26 may provide the data of the acquired image or the information acquired from processing this image as the information about the proof of job completion to the order reception terminal 20.

The processing of the payment remittance support system according to this embodiment will be described next with reference to FIG. 8. In step S21, the order placement terminal 10 provides the contract information. The order placement terminal 10 provides the contract information to the outside of the order placement terminal 10 by storing the contract information in a distributed ledger D. The contract information includes, for example, the order ID, the contents of the job, the payment for the job, and the information about the payer. In step S22, the order placement terminal 10 provides an order placement notification to the order reception terminal 20. For example, the order placement terminal 10 provides the order ID to the order reception terminal 20 such that notification of an order placement for the job indicated in the contract information corresponding to the order ID is performed.

In step S23, the order reception terminal 20 acquires the contract information. For example, the order reception terminal 20 acquires, from the distributed ledger D, contract information corresponding to the order ID provided by the order placement terminal 10. For example, the order receiving entity can confirm the payment for and the contents of the job based on the contract information that has been acquired by the order reception terminal 20. The order reception terminal 20 receives input of information indicating whether to accept the job indicated in the contract information. In step S24, based on the information received as an input from the order receiving entity, the order reception terminal 20 provides an order receipt notification to the order placement terminal 10. The order receipt notification is information indicating that the order for the job indicated in the contract information has been accepted. The order receipt notification is, for example, information which includes the order ID and the payee information. The order receipt notification may be the same as the order receipt information described in FIGS. 4 and 5 or may be information different from the order receipt information.

In step S25, the order reception terminal 20 provides job information to the local terminal 26. The job information is information indicating the contents of the job indicated in the contract information. For example, the worker who holds the local terminal 26 confirms the contents of the job provided from the order reception terminal 20 to the local terminal 26, and performs the job. In step S26, the local terminal 26 acquires the proof of job completion. In step S27, the local terminal 26 provides the information about the proof of job completion acquired in step S26 to the order reception terminal 20.

In step S28, the order reception terminal 20 provides the completion information including the information about the proof of job completion such that the completion information is linked to the contract information. For example, the order reception terminal 20 provides the completion information to the outside of the order reception terminal 20 by storing the completion information which includes the same order ID as the order ID of the contract information in the distributed ledger D. In step S29, the order reception terminal 20 provides a completion notification. The completion notification is information indicating the completion of the job indicated in the contract information. The completion notification includes information (for example, the order ID) which specifies the corresponding contract information. For example, the order reception terminal 20 transmits the order ID linked to the completion information so as to provide the completion notification to the order placement terminal 10.

Based on the completion notification provide from the order reception terminal 20, the order placement terminal 10 acquires the information about the proof of job completion. For example, the order placement terminal 10 searches for the completion information including the order ID provided from the order reception terminal 20 in the distributed ledger D, and acquires the information about the proof of job completion included in this completion information from the distributed ledger D. Based on the information about the proof of job completion acquired by the order placement terminal 10, the order placing entity confirms whether the job has been completed. The order placement terminal 10 receives input of information for executing the remittance processing. In step S31, order placement terminal 10 provides a remittance instruction based on the received information. The remittance instruction includes, for example, information (for example, the order ID) for specifying the contract information and the payee information acquired by the order placement terminal 10 in step S24.

In step S32, the remittance terminal 30 executes the remittance processing based on the remittance instruction provided in step S31. For example, the remittance terminal 30 acquires, from the distributed ledger D, the contract information corresponding to the order ID provided from the order placement terminal 10. The remittance terminal 30 specifies the account of the payer and the payment based on the contract information acquired form the distributed ledger. The remittance terminal 30 also specifies the account of the payee based on the payee information specified in the remittance instruction. The remittance terminal 30 executes processing to transfer value corresponding to the specified payment from the specified account of the payer to the specified account of the payee.

### Third Embodiment

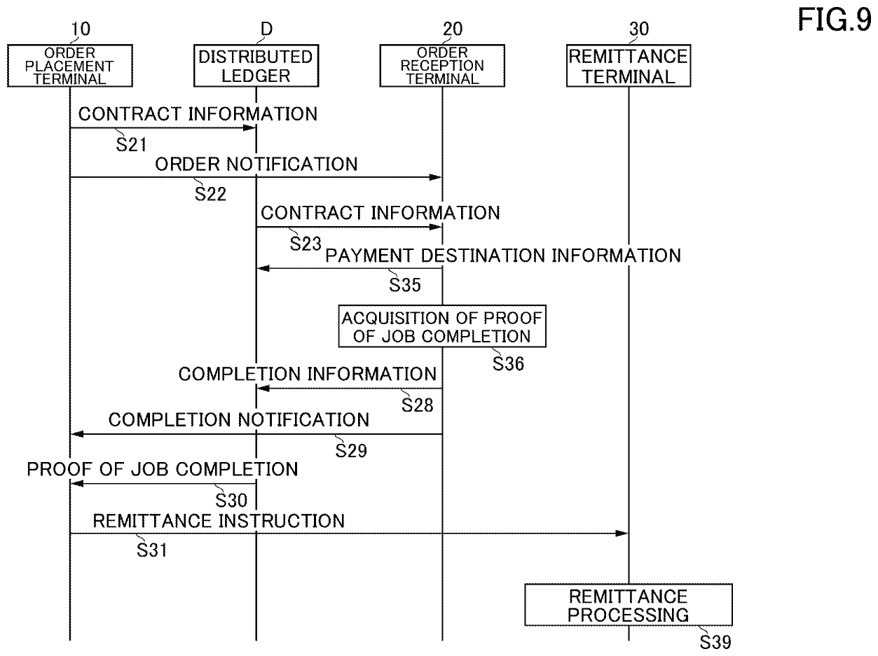

The third embodiment will be described next. In this embodiment, the same reference numbers denote components similar to those of the embodiments described above, and a description thereof will be omitted or simplified. FIG. 9 is a sequence diagram illustrating processing by a payment remittance support system according to this embodiment. In FIG. 9, the processes of steps S21 to S23 are similar to those of FIG. 8, and a description thereof will be omitted.

In step S35, an order reception terminal 20 provides the payee information. The order reception terminal 20 provides the payee information such that the payee information is linked to the contract information corresponding to the order placement notification acquired in step S22. For example, the order reception terminal 20 provides the payee information such that the payee information to is linked to the same order ID as the order ID of the contract information. The order reception terminal 20 provides the payee information to the outside of the order reception terminal 20 by, for example, storing the payee information in a distributed ledger D. The order reception terminal 20 may provide the payee information as the order receipt information. In step S36, the order reception terminal 20 acquires the proof of job completion. The order reception terminal 20 may acquire the proof of job completion by using a camera included in itself as described in FIG. 7. The order reception terminal 20 may also acquire the proof of job completion that is provided from a local terminal 26 as described in FIG. 8. The processes of steps S28 to S31 are similar to those of FIG. 8, and a description thereof will be omitted.

A remittance terminal 30 executes remittance processing in step S39. For example, the remittance terminal 30 acquires the payee information provided from the order reception terminal 20 in step S35. For example, the remittance terminal 30 acquires, from the distributed ledger D, the payee information linked to the order ID indicated in the remittance instruction. The remittance terminal 30 specifies the account of the payee based on the payee information acquired from the distributed ledger D, and executes the remittance processing.

### Fourth Embodiment

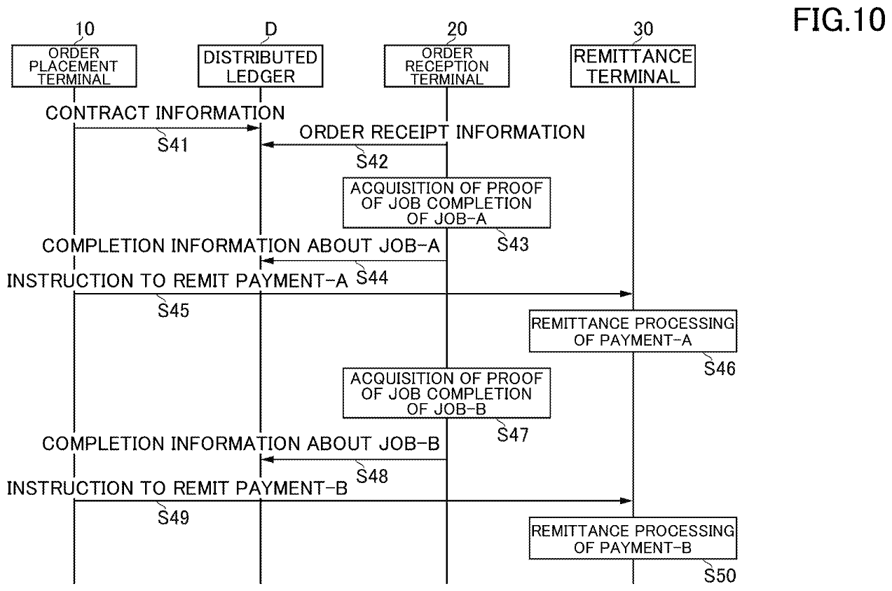

The fourth embodiment will be described next. In this embodiment, the same reference numbers denote components similar to those of the embodiments described above, and a description thereof will be omitted or simplified. In this embodiment, orders for a plurality of jobs are placed and payment is remitted in accordance with the completion of each job. FIG. 10 is a sequence diagram illustrating processing according to a payment remittance support system according to this embodiment. In this embodiment, pieces of information about the plurality jobs are included in the contract information, and the remittance processing for the payment is executed for each job in accordance with the completion information about each job.

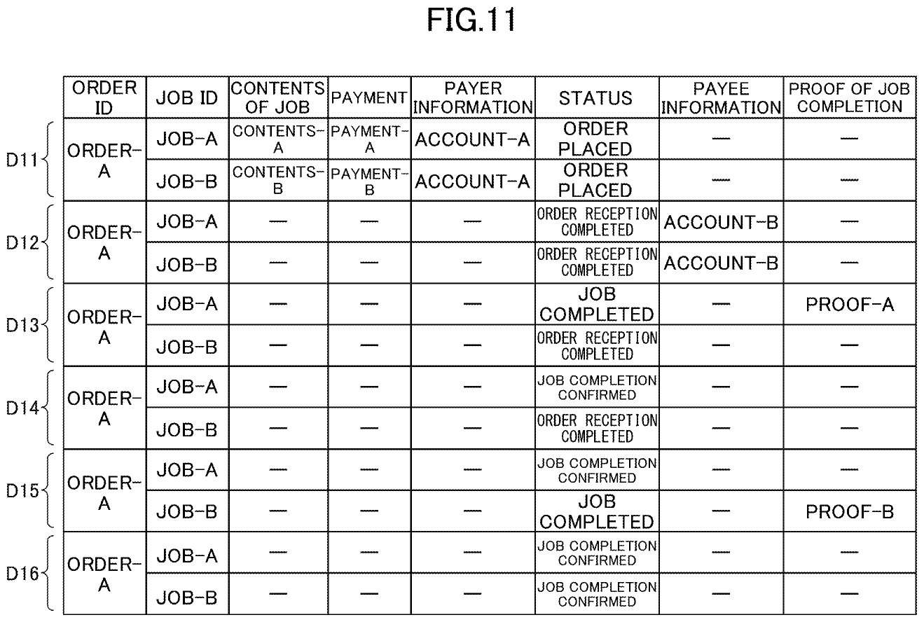

The various types of information used in the processing will be described before the description of the processing of the payment remittance support system. FIG. 11 is a table illustrating an example of the various types of information according to the embodiment. In FIG. 11, reference number D11 corresponds to a piece of contract information. The contract information D11 includes information about the plurality of jobs. The information about each job includes an item for a job ID, an item for the contents of the job, and an item for payment. The job ID is a piece of identification information assigned to each job. For example, two jobs are indicated in the contract information D11, and the respective job IDs of the two jobs are JOB-A and JOB-B. The contents of the job and the payment are defined for each job and are linked to the job ID. For example, in the job linked to JOB-A, the contents of the job is expressed by CONTENTS-A and the payment is expressed by PAYMENT-A. Also, in the job linked to JOB-B, the contents of the job is expressed by CONTENTS-B and the payment is expressed by PAYMENT-B.

In the example of FIG. 11, the contract information D11 includes an item for the payee information. The payee information can be set for each job indicated in the contract information D11. For example, the payer information for PAYMENT-A corresponding to the JOB-A is set to ACCOUNT-A. Also, the payer information for PAYMENT-B corresponding to the JOB-A is set to ACCOUNT-B. Although the payer information is set to the same ACCOUNT-A for both JOB-A and JOB-B, different accounts may be set for JOB-A and JOB-B. Note that the payee information may not be able to be set for each job ID, but may be able to be set for, for example, each order ID. Furthermore, the contract information D11 may not include the payee information.

In the example of FIG. 11, the contract information D11 includes an item for status. For example, the order placing entity places an order for a job to a preselected order receiving entity. Here, the status of each job is set to ORDER PLACED at the stage when the order placement terminal 10 has provided the contract information D11. Thus, the item for the status of each job is indicated as ORDER PLACED in contract information D11. The status information can be set for, for example, each job indicated in the contract information D11. Note that the contract information D11 may not include an item for status.

Reference number D12 in FIG. 11 corresponds to order receipt information. The order receipt information D12 includes an item for payee information. The payee information can be set for each job indicated in the contract information D11. For example, the payee information for PAYMENT-A corresponding to JOB-A is set to ACCOUNT-B. In addition, the payee information for PAYMENT-B corresponding to JOB-B is set to ACCOUNT-B. Although the payee information is set to the same ACCOUNT-B for both JOB-A and JOB-B in this example, different accounts may be set for JOB-A and JOB-B. Note that the payer information may not be able to be set for each job ID, but may be able to be set for, for example, each order ID. Furthermore, the order receipt information D12 may not include the payee information. The order receipt information D12 includes an item for status. The item for status is set to ORDER RECEPTION COMPLETED at the stage when the order receipt information D12 has been provided. Note that the order receipt information may not include an item for status.

Each of reference numbers D13 and D15 in FIG. 11 correspond to contract information. The completion information D13 is the contract information generated when the job of JOB-A is completed. The completion information D13 includes an item for proof of job completion. In the item for proof of job completion in the completion information D13, PROOF-A is stored as the information about the proof of job completion corresponding to JOB-A. The completion information D15 is the completion information generated when the job of JOB-A is completed. The completion information D15 includes an item for proof of job completion. In the item for proof of job completion in the completion information D15, PROOF-B is stored as information about the proof of job completion corresponding to JOB-B. Each of the completion information D13 and the completion information D15 includes an item for status. The item for status is set to JOB COMPLETED at the stage when the information has been provided for the item for proof of job completion. Note that the completion information may not include an item for status.

Each of reference numbers D14 and D16 in FIG. 11 correspond to completion confirmation information. The completion confirmation information D14 is generated based on the completion information D13 related to JOB-A. The completion confirmation information D14 is used as information for executing the remittance processing for PAYMENT-A corresponding to JOB-A. The execution of the remittance processing for PAYMENT-A is triggered based on the provision of the completion confirmation information D14 to the remittance terminal 30. The completion confirmation information D16 is generated based on the completion information D15 related to JOB-B. The completion confirmation information D16 is used as information for executing the remittance processing for PAYMENT-B corresponding to JOB-B. The execution of the remittance processing for PAYMENT-B is triggered by the provision of the completion confirmation information D16 to the remittance terminal 30. Each of the completion confirmation information D14 and the completion confirmation information D16 includes an item for status. The item for status in the completion confirmation information D14 is set to JOB COMPLETION CONFIRMED at the stage when the completion confirmation information D14 is generated. The item for status in the completion confirmation information D16 is set to JOB COMPLETION CONFIRMED at the stage when the completion confirmation information D16 is generated. Note that the completion confirmation information may not include an item for status.

The processing by the payment remittance support system will be described next with reference to FIG. 10. In step S41, the order placement terminal 10 provides the contract information. For example, the order placement terminal 10 provides the contract information D11 to the outside by storing the contract information D11, illustrated in FIG. 11, in a distributed ledger D. In step S42, an order reception terminal 20 provides the order receipt information. For example, the order reception terminal 20 provides the order receipt information D12 to the outside by storing the order receipt information D12, illustrated in FIG. 11, in the distributed ledger D.

The order receiving entity or the worker performs the contents of the job corresponding to JOB-A specified in the contract information. In step S43, the order reception terminal 20 acquires the proof of job completion corresponding to JOB-A. In step S44, the order reception terminal 20 provides the completion information for the JOB-A. For example, the order reception terminal 20 can provide the completion information D13 to the outside of the order reception terminal 20 by storing the completion information D13, illustrated in FIG. 11, in the distributed ledger D. The order placement terminal 10 acquires the completion information D13 provided by the order reception terminal 20. The order placement terminal 10 displays, for example, the completion information D13 and receives input of information indicating that job completion has been confirmed. Based on the received information, the order placement terminal 10 generates, for example, the completion confirmation information D14 illustrated in FIG. 11. The order placement terminal 10 provides the completion confirmation information D14 to the outside by storing the generated completion confirmation information D14 in the distributed ledger D.

In step S45, the order placement terminal 10 provides an instruction to remit PAYMENT-A. For example, the order placement terminal 10 provides, as the remittance instruction, the job ID which is information for specifying the job. For example, the order placement terminal 10 provides the job ID (for example, JOB-A) corresponding to the completion information D13 to the remittance terminal 30. For example, the order placement terminal 10 provides the job ID to the remittance terminal 30 by transmitting information including the job ID to the remittance terminal 30 as the destination. Note that the order placement terminal 10 may also store the information including the job ID in the distributed ledger D and provide the information to the remittance terminal 30 via the distributed ledger D. The information including the job ID may be, for example, the completion confirmation information D14, illustrated in FIG. 11, or may be some other piece of information.

The remittance terminal 30 acquires the remittance instruction for PAYMENT-A provided by the order placement terminal 10 and executes the remittance processing for PAYMENT-A in step S46. For example, based on the job ID provided from the order placement terminal 10, the remittance terminal 30 specifies the information about the payment, the payer information, and the payee information which are linked to the job ID. For example, the remittance terminal 30 uses the job ID to search for the contract information stored in the distributed ledger D and specifies the contract information D11 illustrated in FIG. 11. The remittance terminal 30 specifies, as the information about the payment, PAYMENT-A included in the contract information D11. The remittance terminal 30 specifies, as the payer information, ACCOUNT-A included in the contract information D11. The remittance terminal 30 also uses the job ID to search for the order receipt information stored in the distributed ledger D, and specifies the order receipt information D12 illustrated in FIG. 11. As the payee information, the remittance terminal 30 specifies ACCOUNT-B included in the order receipt information D12.

Furthermore, the order receiving entity or the worker performs the contents of the job corresponding to JOB-B specified in the contract information. In step S47, the order reception terminal 20 acquires the proof of job completion corresponding to JOB-B. In step S48, the order reception terminal 20 provides the completion information about JOB-B. For example, the order reception terminal 20 provides the completion information D15 to the outside of the order reception terminal 20 by storing the completion information D15, illustrated in FIG. 11, in the distributed ledger D. The order placement terminal 10 acquires the completion information D15 provided by the order reception terminal 20. The order placement terminal 10 displays, for example, the completion information D15 to receive an input of information indicating that job completion has been confirmed. Based on the received information, the order placement terminal 10 generates, for example, the completion confirmation information D16 illustrated in FIG. 11. The order placement terminal 10 provides the completion confirmation information D16 to the outside by storing the generated completion confirmation information D16 in the distributed ledger D.

In step S49, the order placement terminal 10 provides an instruction to remit PAYMENT-B. The process of step S49 may be similar to the process of step S45. The remittance terminal 30 acquires the remittance instruction for PAYMENT-B provided by the order placement terminal 10, and executes the remittance processing for PAYMENT-B in step S50. The process of step S50 may be similar to the process of step S46.

The payment remittance support system according to the embodiment described above causes remittance processing to be executed for each of the plurality of jobs, which are specified in the contract information, in accordance with the provision of the completion information for each job. Since such a payment remittance support system can execute remittance of payment for JOB-A without waiting for the provision of the completion information about JOB-B, the convenience and the immediacy can be improved for the order receiving entity.

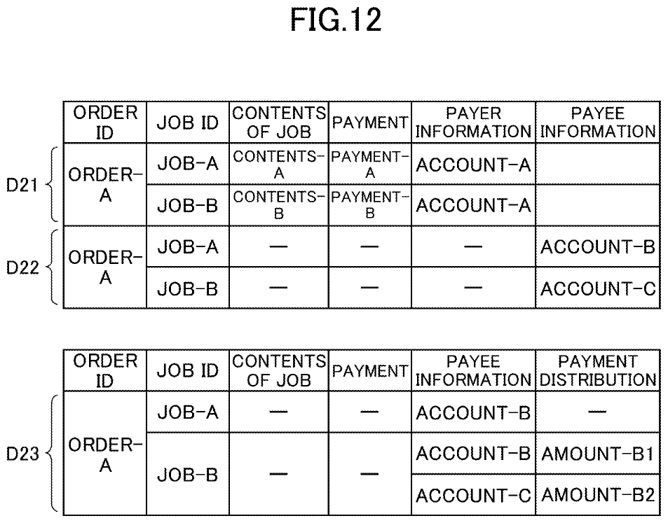

Note that the various types of information illustrated in FIG. 11 are merely examples and can be changed appropriately. FIG. 12 is a view illustrating the various types of information related to a modification. Reference number D21 corresponds to contract information, and reference number D22 corresponds to order receipt information corresponding to the contract information D21. In the contract information D21, the payee information can be set for each job. For example, in the order receipt information D22, the payee information linked to JOB-A is ACCOUNT-B, and the payee information linked to JOB-B is ACCOUNT-C.

Such order receipt information D22 is used in a case where, for example, the order receiving entity places an order for JOB-B again. In the following description, an order receiving entity which accepts a job ordered by an order placing entity will be referred to as a primary order receiving entity, and an order receiving entity which accepts a job ordered again from the primary order receiving entity will be referred to as a secondary order receiving entity. Note that an order placing entity may be referred to as a primary order placing entity, and the primary order receiving entity may be referred to as a secondary order placing entity. In the order receipt information D22, ACCOUNT-B corresponds to, for example, the payee information about the primary order receiving entity, and ACCOUNT-C corresponds to, for example, the payee information about the secondary order receiving entity. Assume here that an order for JOB-B has been placed again from the primary order receiving entity to the secondary order receiving entity, and the payee information about the JOB-B has been set to ACCOUNT-B. In this case, the payment for JOB-B is remitted from the order placing entity to the primary order receiving entity, and the payment is further remitted from the primary order receiving entity to the secondary order receiving entity. Compared to such a configuration, this modification can reduce processes related to remittance, thereby improving the convenience and the immediacy for the order receiving entities.

Note that the payee information may be information concealed from the order placing entity. For example, the payee information may be stored as information to which the order placement terminal 10 has no access privilege. Such a configuration can contribute to the protection of secret information about the order receiving entity when, for example, the payee information corresponds to a trade secret. Each of ACCOUNT-B and ACCOUNT-C may be the payee information for the same order receiving entity. For example, ACCOUNT-B may be an account for managing payments in a department which is in charge of JOB-A in the primary order receiving entity, and ACCOUNT-C may be an account for managing payments in a department which is charge of JOB-B in the same primary order receiving entity.

Reference number D23 in FIG. 12 corresponds to order receipt information which is in a different form than the order receipt information D22. In the order receipt information D23, a plurality of pieces of payee information can be set to a single job. For example, ACCOUNT-B and ACCOUNT-C have been set as the payee information for the payment of JOB-B. The order receipt information D23 also includes an item for payment distribution. Payment distribution is information indicating the distribution of an amount to be remitted to ACCOUNT-B and an amount to be remitted to ACCOUNT-C in PAYMENT-B indicated in the contract information D21. For example, the payment distribution to ACCOUNT-B for the payment of JOB-B is set to AMOUNT-B1, and the payment distribution to ACCOUNT-C for the payment of JOB-B is set to AMOUNT-B2. Each of AMOUNT-B1 and AMOUNT-B2 may be information indicating a value of payment or may be information indicating a ratio of the payment. AMOUNT-B1 is, for example, a payment (for example, a commission or a management fee) to be received by the primary order receiving entity which accepted JOB-B from ORDER PLACING ENTITY-B. AMOUNT-B2 is a payment (for example, a wage) to be received by the secondary order receiving entity which accepted the order for JOB-B from the primary order receiving entity.

Such a configuration can reduce, for example, the labor required for remitting payment, thus contributing to the improvement in the convenience and the immediacy for the order placing entity and/or the order receiving entity. Note that the payee information and the payment distribution may be pieces of information which are to be concealed from the order placing entity. For example, the payee information and the payment distribution may be stored as pieces of information to which the order placement terminal 10 has no access privilege. Such a configuration can contribute to the protection of secret information about the order receiving entity in a case where, for example, the payee information and the payment distribution correspond to the trade secrets of the order receiving entity. ACCOUNT-B and ACCOUNT-C may both be the payee information for the same order receiving entity.

### Fifth Embodiment

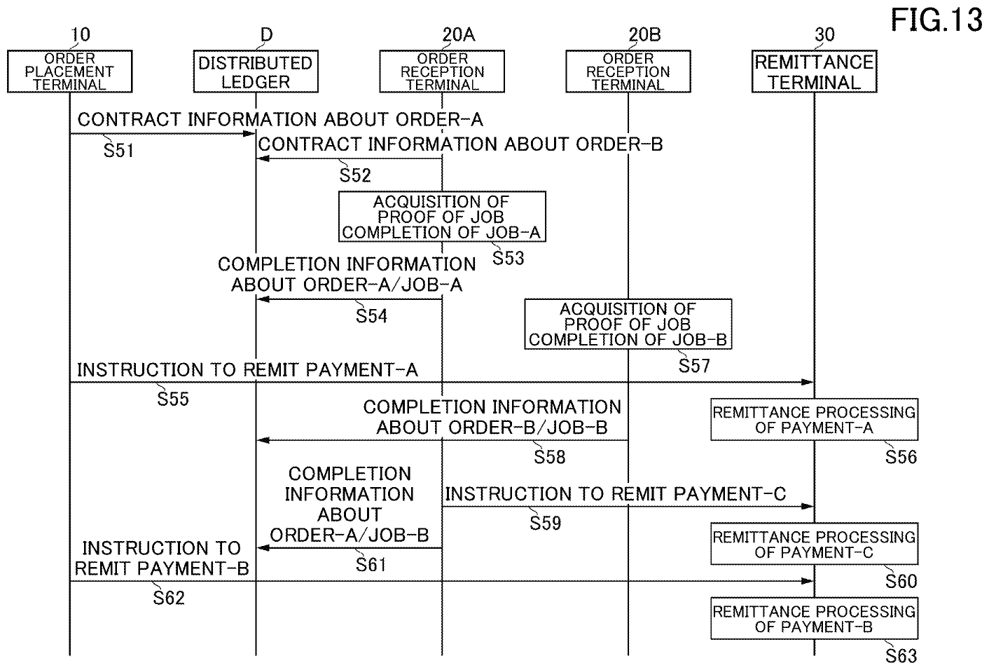

The fifth embodiment will be described next. In this embodiment, the same reference numbers denote components similar to those of the embodiments described above, and a description thereof will be omitted or simplified. This embodiment has a configuration in which orders are placed for a plurality of jobs, and a payment is remitted in accordance with the completion of each job. FIG. 13 is a sequence diagram illustrating the processing of a payment remittance support system according to this embodiment. The payment remittance support system includes an order reception terminal 20A and an order reception terminal 20B. The order reception terminal 20A is a terminal used by a primary order receiving entity. The order reception terminal 20B is a terminal used by a secondary order receiving entity. In this embodiment, the primary order receiving entity can use the payment remittance support system to order at least part of an accepted job to the secondary order receiving entity.

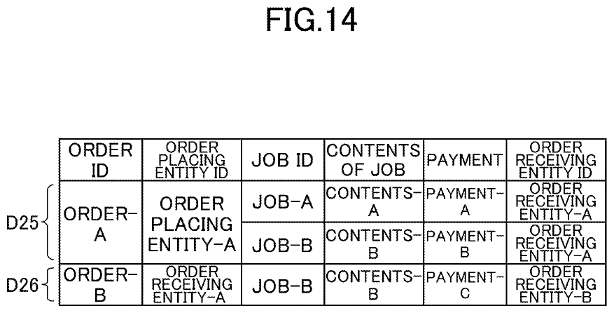

The various types of information used in the processing will be described before the description of the processing of the payment remittance support system. FIG. 14 is a table illustrating an example of various types of information according to the embodiment. Reference number D25 in FIG. 14 corresponds to contract information provided from an order placing entity to a primary order receiving entity. The order receiving entity ID of the primary order receiving entity is ORDER RECEIVING ENTITY-A. The contract information D25 includes information about a plurality of jobs. The information about each job includes an item for the job ID, an item for contents of the job, and an item for payment. Two jobs are indicated in the contract information D25. The job IDs of the two jobs are JOB-A and JOB-B. The contents of the job linked to JOB-A is JOB-A, and the payment linked to JOB-A is PAYMENT-A. The contents of the job linked to JOB-B is JOB-B and the payment linked to JOB-B is PAYMENT-B. The contract information D25 includes an item for an order placing entity ID that is the identification information about the order receiving entity which accepted each job. ORDER RECEIVING ENTITY-A is indicated as the order placing entity ID for each of JOB-A and JOB-B in the contract information D25. Assume here that a primary order receiving entity places an order for the job of JOB-B to a secondary order receiving entity.

Reference number D26 in FIG. 14 corresponds to contract information provided from the primary order receiving entity to the secondary order receiving entity. The order ID in the contract information D26 is ORDER-B and differs from ORDER-A which is the order ID of the contract information D25. The order placing entity ID in the contract information D26 differs from the order placing entity ID as the order placing entity ID in the contract information D25. Assume here that ORDER RECEIVING ENTITY-A is the order placing entity ID in the contract information D26. The order placing entity ID in the contract information D26 may be the identification information issued separately from ORDER RECEIVING ENTITY-A to the primary order receiving entity, and may be different from ORDER RECEIVING ENTITY-A.

The job ID in the contract information D26 is JOB-B. Here, some of the jobs in the contract information D25 and the contract information D26 have the same job ID. The job ID in contract information D26 may be assigned separately from the job ID in the contract information D26, and may not be JOB-B. In the contract information D26, the contents of the job linked to JOB-B is CONTENTS-B. In this example, the contents of the job linked to JOB-B are the same (for example, CONTENTS-B) as the contract information D25 and the contract information ID, but at least some of the contents may be different. For example, the contents of the job linked to JOB-B in the contract information D26 may be information that expresses the contents of the job, which is linked to the JOB-B in the contract information D25, in a different manner. In the contract information D26, the payment linked to JOB-B is PAYMENT-C. PAYMENT-C may have the same value as PAYMENT-B or have a different value. For example, PAYMENT-C may be an amount obtained by subtracting a commission or a management fee, which is required by the primary order receiving entity for executing order reception again, from PAYMENT-B. Furthermore, the primary order receiving entity may place an order for an urgent job to the secondary order receiving entity, and the amount of PAYMENT-C may be an amount obtained by adding an allowance for expedited service to PAYMENT-B. The order receiving entity ID linked to JOB-B in the contract information D26 is ORDER RECEIVING ENTITY-B and is different from ORDER RECEIVING ENTITY-A which is the order receiving entity ID linked to JOB-B in the contract information D25.

The contract information D26 may be handled as information that is independent of the contract information D25. For example, at least a part of the contract information D25 may be set as information hidden from the terminal of the secondary order receiving entity. In addition, at least a part of the contract information D26 may be set as information hidden from the terminal of the order placing entity. The at least a part of the contract information D26 may be information associated with the at least a part of the contract information D25. For example, the contents of the job in the contract information D26 may be expressed by a link to the contents of the job in contract information D25.

The processing by the payment remittance support system will be described next with reference to FIG. 13. In step S51, an order placement terminal 10 provides the contract information about ORDER-A. For example, the order placement terminal 10 stores the contract information D25, which is indicated in FIG. 14, in the distributed ledger D. The order reception terminal 20A acquires the contract information provided by the order placement terminal 10. For example, the order reception terminal 20A receives the notification about an order ID from the order placement terminal 10, and acquires the contract information linked to the order ID from the distributed ledger D. For example, the primary order receiving entity confirms the contract information about ORDER-A, and places an order to the secondary order receiving entity for JOB-B. The order reception terminal 20A uses, for example, the information input from the primary order receiving entity to generate the contract information for ORDER-B. In step S52, the order reception terminal 20A provides the contract information for ORDER-B. For example, the order reception terminal 20A stores the contract information D26, which is indicated in FIG. 14, in the distributed ledger D. The order reception terminal 20B acquires the contract information provided by the order reception terminal 20B. For example, the order reception terminal 20B receives a notification about an order ID from the order reception terminal 20A, and acquires the contract information linked to the order ID from the distributed ledger D.

The primary order receiving entity uses the contract information for the ORDER-A to confirm the contents of the job of JOB-A, and completes the job of JOB-A. In step S53, the order reception terminal 20A acquires the proof of job completion of JOB-A. In step S54, the order reception terminal 20A provides the completion information related to JOB-A of ORDER-A. For example, the order reception terminal 20A stores the completion information linked to the contract information about ORDER-A in the distributed ledger D. The order placement terminal 10 acquires the completion information provided by the order reception terminal 20A. In step S55, the order placement terminal 10 provides an instruction to remit PAYMENT-A based on the completion information corresponding to JOB-A of ORDER-A. The remittance terminal 30 acquires the remittance instruction for PAYMENT-A provided by the order placement terminal 10. In step S56, the remittance terminal 30 executes the remittance processing for PAYMENT-A based on the remittance instruction for PAYMENT-A.

The secondary order receiving entity uses the contract information about ORDER-B to confirm the contents of the job of JOB-B, and completes the job of JOB-B. In step S57, the order reception terminal 20B acquires the proof of job completion of JOB-B. In step S58, the order reception terminal 20B provides the completion information related to JOB-B of ORDER-B. For example, the order reception terminal 20B stores the completion information linked to the contract information for ORDER-B in the distributed ledger D. The order reception terminal 20A acquires the completion information provided by the order reception terminal 20B. In step S59, the order reception terminal 20A provides an instruction to remit PAYMENT-C based on the completion information corresponding to JOB-B of ORDER-B. The remittance terminal 30 acquires the remittance instruction for PAYMENT-C provided by the order reception terminal 20B. In step S60, the remittance terminal 30 executes the remittance processing for PAYMENT-C based on the remittance instruction for PAYMENT-C.

In step S61, the order reception terminal 20A provides the completion information related to JOB-B of ORDER-A. For example, the order reception terminal 20A stores the completion information linked to the contract information for ORDER-A in the distributed ledger D. The order placement terminal 10 acquires the completion information provided by the order reception terminal 20A. In step S62, the order placement terminal 10 provides an instruction to remit PAYMENT-B based on the completion information corresponding to JOB-B of ORDER-A. The remittance terminal 30 acquires the remittance instruction for PAYMENT-B provided by the order placement terminal 10. In step S63, the remittance terminal 30 executes the remittance processing for PAYMENT-B based on the remittance instruction for PAYMENT-B.

In the embodiment, the contract information includes the contents of a plurality of jobs and information indicating the payment for each job; the order reception terminal provides, as the completion information, information indicating the completion of at least one job among the plurality of jobs; and the remittance unit causes, as the remittance processing, processing for remitting the payment indicated in the contract information for the at least one job to be executed. The number of jobs indicated in the contract information may be one. When an order is placed for a plurality of jobs, the contract information may be provided for each job. The remittance unit may execute the remittance processing in response to the completion information about two or more jobs. The remittance unit may execute processing to remit the payments for the two or more jobs in a lump sum.

Note that the order in which the processes from step S53 to step S63 are executed may be changed within a range that is not logically inconsistent. For example, one or both of the processes of step S57 and step S58 may be performed after the process of step S52, before the process of step S53, or in parallel with at least a portion of the process of step S53. One or both of the processes of step S57 and step S58 may be performed after the process of step S52, before the process of step S54, or in parallel with at least a portion of step S54. The process of step S61 may be performed after the process of step S58, before the process of step S59, or in parallel with at least a portion of step S59.

### Sixth Embodiment

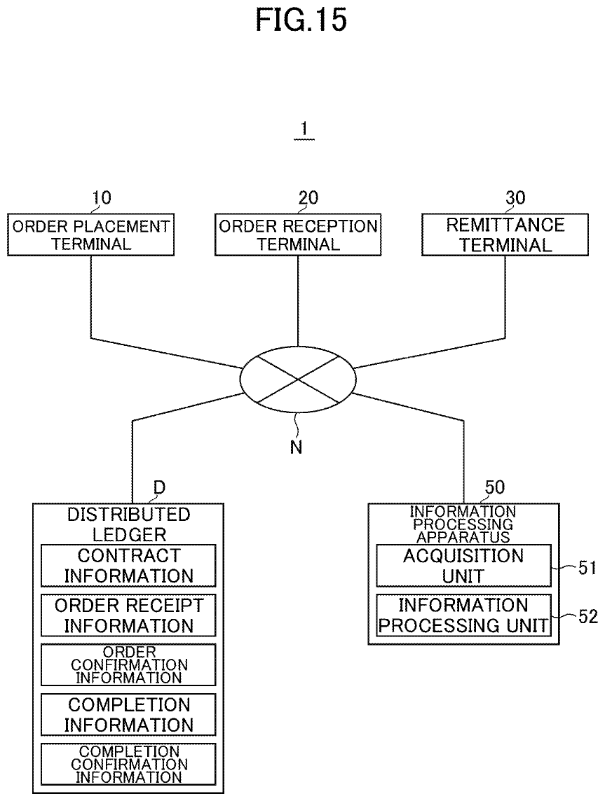

The sixth embodiment will be described next. In this embodiment, the same reference numbers denote components similar to those of the embodiments described above, and a description thereof will be omitted or simplified. FIG. 15 is a block diagram illustrating a payment remittance support system according to the embodiment. A payment remittance support system 1 according to this embodiment includes an information processing apparatus 50. The information processing apparatus 50 includes an acquisition unit 51 and an information processing unit 52. The acquisition unit 51 acquires contract information and information linked to the contract information. The acquisition unit 51 acquires the information stored in a distributed ledger D. The information processing unit 52 analyzes the relationship between the contract information and the information linked to the contract information. The information processing unit 52 analyzes the information acquired by the acquisition unit 51.

The information processing apparatus 50 performs machine learning on, for example, the success or failure of a job with respect to the contents of the job. For example, the information processing unit 52 uses training data including input data which indicate the contents of jobs and output data which indicate the success or failure of each job. For example, with respect to input data including the contents of a job which is expected to be ordered, the information processing apparatus 50 uses the result of machine learning to predict the success or failure of the job. The information processing apparatus 50 predicts, for example, the success or failure of a job indicated in the contract information provided by an order placement terminal 10. The aforementioned input data may include information (for example, an order receiving entity ID) of an expected order receiving entity. The order placement terminal 10 acquires a prediction result provided by the information processing apparatus 50 about the success or failure of the job. An order placing entity can determine whether to place an order for the job indicated in the contract information based on the prediction result acquired by the order placement terminal 10 about the success or failure of the job.

Although the information processing apparatus 50 analyzes, for example, the relationship between the contents of a job and the success or failure of the job, other pieces of information may be analyzed. For example, the information processing apparatus 50 may analyze the relationship between the contents of a job, the information about the payment, and the success or failure of order reception. For example, the information processing apparatus 50 performs machine learning by using training data that includes input data including the contents of jobs, the information about the payments and output data indicating the success or failure of each order reception. For example, with respect to input data including the contents and the payment of a job which is expected to be ordered, the information processing apparatus 50 uses the result of machine learning to predict the success or failure of the order reception of job. For example, the information processing apparatus 50 predicts the success or failure of the order reception of the job indicated in the contract information provided by the order placement terminal 10, and provides the prediction result as the output data. The aforementioned input data may include information (for example, the order receiving entity ID) of an expected order receiving entity. The order placement terminal 10 acquires the prediction result provided by the information processing apparatus 50 about the success or failure of order reception. Based on the prediction result acquired by the order placement terminal 10 about the success or failure of the order reception, the order placing entity can determine whether to place an order for the job indicated in the contract information. The information processing apparatus 50 may predict the success or failure of the order reception by using the payment as a parameter, and calculate a payment predicted to lead to success in order reception. The information processing apparatus 50 may provide the information about the calculated payment. The order placement terminal 10 may acquire the information provided by the information processing apparatus 50 about the payment, and use the information to decide the payment information in the contract information.

In addition, the information processing apparatus 50 may analyze the tendency of the contents of the job indicated in the contract information. For example, the information processing apparatus 50 may use a plurality of pieces of contract information to perform character recognition and analysis on the contents of jobs, and extract the condition of a job which has a relatively high frequency of appearance. For example, when the job to be ordered is delivery, the information processing apparatus 50 may extract the type of cargo, the route, the period of time, and the like with a high frequency of order reception. The information processing apparatus 50 may provide an analysis result acquired by analyzing the contract information. The order reception terminal 20 may acquire the analysis result provided by the information processing apparatus 50. For example, the order receiving entity can use the analysis result acquired by the order reception terminal 20 to have a grasp of jobs that are in high demand. As a result, the order receiving entity can take measures such as preparing a structure that will allow orders to be accepted.

The information processing apparatus 50 may also analyze the payment remittance record indicated in the contract information. Assume here that a remittance terminal 30 remits at least a part of the payment in advance on behalf of the payer when the balance of the account of the payer is less than the payment. The information processing apparatus 50 may analyze the frequency at which an advance payment occurs, the period from the occurrence of the advance payment to the reimbursement of the payment, and the like for each order receiving entity ID or for the account of each payer. The information processing apparatus 50 may also evaluate the status of remittance of the payment. The information processing apparatus 50 may provide an analysis result. The remittance terminal 30 may acquire the analysis result provided by the information processing apparatus 50. For example, a remitting entity may use an analysis result acquired by the remittance terminal 30 to determine whether to give credit, to pay in advance on the behalf of the payer, or the like.

Note that the information processing apparatus 50 may analyze (for example, evaluate) information that is different from the relationship between the contract information and the information linked to the contract information. The information processing apparatus 50 may not analyze the relationship between the contract information and the information linked to the contract information. At least some of the functions of the information processing apparatus 50 may be provided in one (for example, the order placement terminal 10, an order reception terminal 20, or the remittance terminal 30) of the terminals forming the payment remittance support system 1. The payment remittance support system 1 may not include the information processing apparatus 50. The information processing apparatus 50 may be provided separately from the payment remittance support system 1.

Note that the technical scope of the present disclosure is not limited to the aspects described in the above-described embodiments. One or more of the elements described in the above-described embodiments may be omitted. The elements described in the above-described embodiments can also be appropriately combined. Furthermore, the disclosures of all the documents cited in the above-described embodiments and the like are incorporated herein by reference to the extent permitted by the laws and regulations of the country or region to which the present specification is applied.

### REFERENCE SIGNS LIST

1 payment remittance support system
10 order placement terminal
15 remittance unit
20, 20A, 20B order reception terminal
50 information processing apparatus
51 acquisition unit
52 information processing unit
D distributed ledger
D1 contract information
D4 completion information

1. A payment remittance support system comprising:
an order placement terminal configured to provide contract information indicating a payment for and contents of a job for which an order is placed;
an order reception terminal configured to provide completion information, which indicates completion of the job for which the order was accepted, such that the completion information is linked to the contract information; and
a remittance unit configured to cause remittance processing for the payment indicated in the contract information linked to the completion information to be executed.

2. The payment remittance support system according to claim 1, wherein the order placement terminal is configured to provide the contract information by storing the contract information in a distributed ledger, and
wherein the remittance unit is configured to execute the remittance processing based on the contract information stored in the distributed ledger.

3. The payment remittance support system according to claim 1, wherein the order placement terminal includes the remittance unit,
wherein the remittance unit provides, based on the completion information provided to the order placement terminal, completion confirmation information, which indicates confirmation of the completion of the job, such that the completion confirmation information is linked to the contract information, and
wherein the remittance processing is executed by a remittance terminal to which the completion confirmation information is provided.

4. The payment remittance support system according to claim 1, wherein information indicating an account of a payer of the payment is provided by being linked to the contract information, and
wherein the remittance processing includes a process of specifying the account of the payer by using the contract information linked to the completion information.

5. The payment remittance support system according to claim 1, wherein the order reception terminal is configured to provide the completion information by storing the completion information in a distributed ledger the distributed ledger, and
wherein the remittance unit is configured to execute the remittance processing based on the completion information stored in the distributed ledger.

6. The payment remittance support system according to claim 1, wherein information indicating an account of a payee of the payment is linked to the contract information, and
wherein the remittance processing includes a process of specifying the account of the payee by using the contract information linked to completion confirmation information which indicates confirmation of the completion of the job.

7. The payment remittance support system according to claim 6, wherein the information indicating the account of the payee is set as information hidden from the order placement terminal.

8. The payment remittance support system according to claim 1, wherein the contract information includes information indicating contents of a plurality of jobs and a payment for each job,
wherein the order reception terminal is configured to provide, as the completion information, information indicating completion of at least one job among the plurality of jobs, and
wherein the remittance unit is configured to cause processing for remitting the payment indicated for the at least one job in the contract information to be executed as the remittance processing.

9. The payment remittance support system according to claim 1, wherein the contract information includes identification information, and
wherein the completion information includes the identification information and proof indicating the completion of the job, and is linked to the contract information by the identification information.

10. The payment remittance support system according to claim 1, further comprising an information processing unit configured to analyze a relationship between the contract information and information linked to the contract information.

11. The payment remittance support system according to claim 10, wherein the information processing unit is configured to perform machine learning by training data using input data, which uses at least a part of the contract information provided and stored from the order placement terminal, and output data, which uses at least a part of the information linked to the contract information.

12. An information processing apparatus comprising:
an acquisition unit configured to acquire contract information indicating a payment for and contents of a job for which an order is placed; and
an information processing unit configured to analyze a relationship between the contract information and information linked to the contract information.

13. A payment remittance support method comprising:
providing, by an order placement terminal, contract information indicating a payment for and contents of a job for which an order is placed;
providing, by an order reception terminal, completion information, which indicates completion of the job for which the order was accepted, such that the completion information is linked to the contract information; and
causing remittance processing for the payment indicated in the contract information linked to the completion information to be executed.

14. A non-transitory computer-readable storage medium storing a program configured to cause a computer to execute remittance processing for a payment based on contract information, which indicates the payment for and contents of a job for which an order is placed, and completion information, which is linked to the contract information and is information indicating completion of the job for which the order was accepted.
